(19) United States
(12) Patent Application Publication
(10) Pub. No.: US 2015/0304853 A1
(43) Pub. Date: Oct. 22, 2015

(54) Channel Evacuation Procedures for Wireless Networks Deployed in Dynamic Shared Spectrum

(71) Applicant: INTERDIGITAL PATENT HOLDINGS, INC., Wilmington,, DE (US)

(72) Inventors: Joseph M. Murray, Schwenksville, PA (US); Martino M. Freda, Laval (CA)

(73) Assignee: INTERDIGITAL PATENT HOLDINGS, INC., Wilmington, DE (US)

(21) Appl. No.: 14/443,140

(22) PCT Filed: Nov. 15, 2013
(86) PCT No.: PCT/US2013/070338

§ 371 Date: May 15, 2015

Related U.S. Application Data
(60) Provisional application No. 61/726,871, filed on Nov. 15, 2012.

(51) Int. Cl. H04W 16/14; H04W 76/06

(52) U.S. Cl. CPC H04W 16/14; H04W 76/068; H04W 92/20

(57) ABSTRACT

Systems, methods, and instrumentalities are described for channel evacuation of a shared spectrum channel A secondary user base station may provide one or more secondary user wireless transmit receive unit (WTRUs) access to a shared spectrum channel. The secondary user base station may receive an evacuation message indicating a need for the secondary user WTRUs to evacuate the shared spectrum channel. The secondary user base station may coordinate channel evacuation of the shared spectrum channel in response to the evacuation message. A secondary user WTRU may detect an incumbent user. The secondary user WTRU may receive an incumbent detection measurement configuration. The secondary user WTRU may detect whether an incumbent user is present on a shared spectrum channel and may send a detection message upon detection of the incumbent user. The secondary user WTRU may receive a reconfiguration message in response to the detection message.

### CROSS REFERENCE TO RELATED APPLICATIONS

This application claims the benefit of U.S. Provisional Patent Application No. 61/726,871 filed Nov. 15, 2012, the contents of which are hereby incorporated by reference herein.

### BACKGROUND

When a wireless system operates in a secondary fashion in dynamic shared spectrum (DSS), it may allow usage of the spectrum to a system which has a higher usage priority for the spectrum. Such higher priority systems may include primary users (PU) in Television White Space (TVWS), or Licensed Shared Access (LSA) incumbents in case of the spectrum under the LSA regime.

To operate in DSS such as TVWS, the devices (e.g., complying with regulatory requirements) may benefit by gaining access to free channels. In major cities that have limited or no TVWS channels available, sensing only operation may become essential as a means to gain access to more channels. Below roof line deployments, for example, may benefit from the isolation brought by the urban landscape from the digital TV (DTV) transmitters. Further, indoor deployments may benefit from the indoor penetration loss. In this context, sensing only operation may comply with specific requirements on Spectrum Sensing allowing a small cell network to make use of a PU-assigned channel. The PU-Assigned channel (e.g., assigned to a primary user) may require a secondary user (SU) to leave the channel, if the primary user is detected. Similarly, the LSA regime may ensure the protection of the LSA incumbent to interference from the LSA licensee, as well as a guarantee that the LSA incumbent has prioritized access to the spectrum that the incumbent owns and sublicenses. The connected mode mechanisms may be needed to provide support for PU detection, reporting and/or channel evacuation, e.g., when a system operates on DSS spectrum in a secondary fashion.

### SUMMARY OF THE INVENTION

Systems, methods, and instrumentalities are described for channel evacuation of a shared spectrum channel. In shared spectrum, a secondary user system may use spectrum. The spectrum may be utilized and/or controlled by an incumbent system. A secondary user base station may provide one or more secondary user wireless transmit receive unit (WTRUs) access to a shared spectrum channel. The secondary user base station may include, but not limited to, a licensed shared access (LSA) licensee base station, a TVWS base station, a dynamic shared spectrum access point and/or the like.) The secondary user base station may receive an evacuation message indicating a need for the secondary user base station and WTRUs to evacuate the shared spectrum channel. The evacuation message may include an alternate channel for use by the secondary user WTRUs. The evacuation message may include a system evacuation message. The secondary user base station may receive the evacuation message from a database entity or a broker entity. The secondary user base station may check the status of a shared spectrum channel with a database or a broker to determine the need to evacuate the shared spectrum channel. The secondary user may receive an evacuation message in response to the shared spectrum channel status check.

The secondary user base station may receive the evacuation message from a management entity, e.g., based on a pre-determined channel evacuation time. The pre-determined channel evacuation time may be based on an agreement between an incumbent system operator and a secondary user operator. The allowable use of the channel by the secondary system may be periodic. The evacuation time may re-occur one or more times. The pre-determined evacuation time may be based on an allowed time for the use of the shared spectrum channel by the secondary user WTRUs. The shared spectrum channel may be an LSA channel.

The secondary user base station may coordinate channel evacuation of the shared spectrum channel in response to the evacuation message. The secondary user base station may send an evacuation complete message to an incumbent user (e.g., an incumbent base station). The incumbent user may be the primary user (PU). The evacuation complete message may indicate to the incumbent user that the evacuation of the shared spectrum channel has been completed. The system evacuation message may comprise an X2 message received via an X2 interface. The secondary user base station may select a target cell, e.g., based on at least one of an event notification, a secondary user WTRU measurement report, or an neighbor relational table (NRT) entry. The secondary user base station may send a handover request to the target cell.

The secondary user base station may send a measurement event configuration to the secondary user WTRUs. The measurement event configuration may include at least one of a public land mobile network identifier (PLMN ID) or a request for performing a PLMN search on the shared spectrum channel based on the PLMN ID. The PLMN ID to be search may be associated with an incumbent user. The secondary user WTRU's may be asked to trigger an event notification to the secondary user base station, e.g., when the PLMN ID is detected following configuration of the measurement event. An evacuation message may be received in response to the notification.

A secondary user WTRU may detect an incumbent user (e.g., operating on the shared spectrum channel). The secondary user WTRU may receive an incumbent detection measurement configuration. The incumbent detection measurement configuration may include an incumbent cell identifier (ID) (e.g., one or more of a physical cell identifier (PCI) or a PLMN ID) associated with the incumbent user.

The secondary user WTRU may detect whether an incumbent user is present on a shared spectrum channel, e.g., based on the incumbent detection measurement configuration. The secondary user WTRU may send a detection message upon detection of the incumbent user. The detection message may be sent via an uplink incumbent user detection media access control (MAC) control element (CE) or via a radio resource control (RRC) message. The detection message may include an event notification. The event notification may indicate the presence of the incumbent user. The secondary user WTRU may receive an evacuation message from the secondary user base station in response to the detection message.

The secondary user WTRU may receive a reconfiguration message in response to the detection message. The reconfiguration message may include an identification of a target cell. The secondary user WTRU may update its radio resource configuration based on the received reconfiguration message. The secondary user WTRU may send a reconfiguration complete message to the target cell.

The secondary user WTRU may start a timer with a value upon the detection of the incumbent user. The value of the timer may be assigned in such a way to stagger the connection request. The secondary user WTRU may send a connection request to a target cell upon an expiry of the timer.

The secondary user WTRU may start a timer with a value upon the detection of the incumbent user. The secondary user WTRU may stop the timer, e.g., upon a condition that a handover command or a release command is received before an expiry of the timer. The secondary user WTRU may attempt to establish a connection based on the handover command or the release command. Different timer values may be used to stagger the re-establishment attempts for the secondary user WTRUs.

The secondary user WTRU may receive a connection release message (e.g., via a downlink MAC CE) in response to the evacuation message. The connection release message may indicate the presence of the incumbent user as a release cause.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 1F illustrates an example of an Evolved Universal Terrestrial Radio Access Network (E-UTRAN) architecture.

FIG. 1G illustrates an example of system information acquisition.

FIG. 1H illustrates an example of an intra mobile management entity (MME) and/or serving gateway (S-GW) handover (HO).

FIG. 1I illustrates an example of a successful radio resource control (RRC) connection re-establishment.

FIG. 1J illustrates an example of rejection of RRC connection re-establishment.

FIG. 1K illustrates an example of an RRC connection release.

FIG. 1L illustrates an example of automatic neighbor relation (ANR) block diagram.

FIG. 1M illustrates an example of utilization of the automatic neighbor relation (ANR) function.

FIG. 1N illustrates an example of the TV band spectrum usage.

FIG. 2 illustrates an example of an architecture that may be used for evacuation at a known time instant.

FIG. 3 illustrates an example of system evacuation, e.g., signaled by a licensed shared access (LSA) incumbent.

FIG. 4 illustrates an example of system evacuation, e.g., using synchronization channel (SCH)/reference signal (RS) transmission.

FIG. 5 illustrates an example of system evacuation, e.g., using a modified random access channel (RACH) procedure.

FIG. 6 illustrates an example of system evacuation, e.g., triggered by an active database or broker.

FIG. 7 illustrates an example of system evacuation, e.g., triggered by a passive database or broker.

FIG. 8 illustrates an example of a frequency information information element (IE).

FIG. 9 illustrates an example of an uplink primary user (UL PU) detection medium access control (MAC) control element (CE).

FIG. 10 illustrates an example of a modified system information block (SIB), e.g., SIB2.

FIG. 11 illustrates an example of a RACH-based PU detection.

FIG. 12 illustrates an example of a WTRU channel evacuation via handover (HO).

FIG. 13 illustrates an example of a WTRU channel evacuation via RRC connection re-establishment following HO failure.

FIG. 14 illustrates an example of WTRU channel evacuation via RRC connection release.

FIG. 15 illustrates an example of an information element indicating a release cause.

FIG. 16 illustrates an example of a shared spectrum channel evacuation.

FIG. 17 illustrates an example of detecting the presence of an incumbent user, reporting the presence of the incumbent user, and receiving an evacuation message.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application. In addition, the figures may illustrate flow charts, which are meant to be exemplary. Other embodiments may be used. The order of the messages may be varied where appropriate. Messages may be omitted if not needed, and, additional flows may be added.

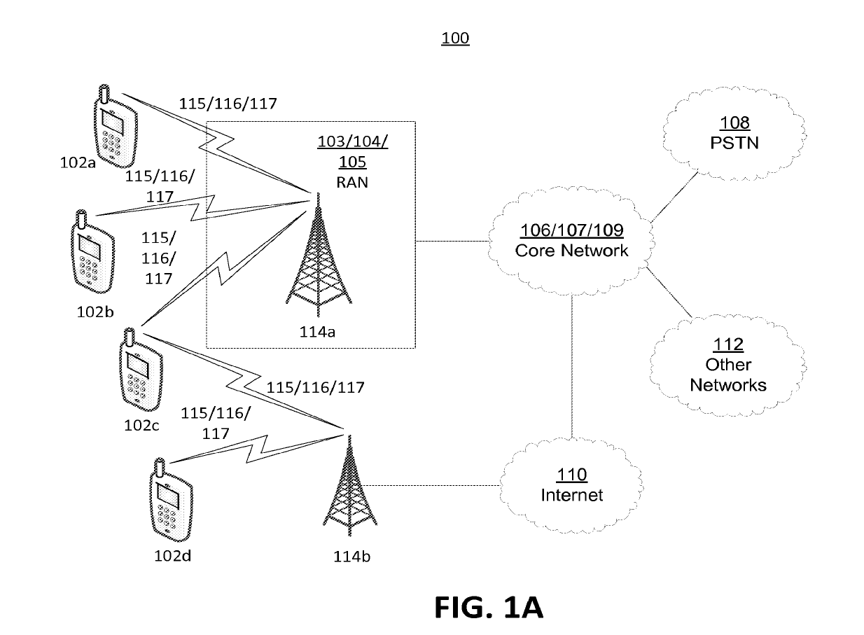

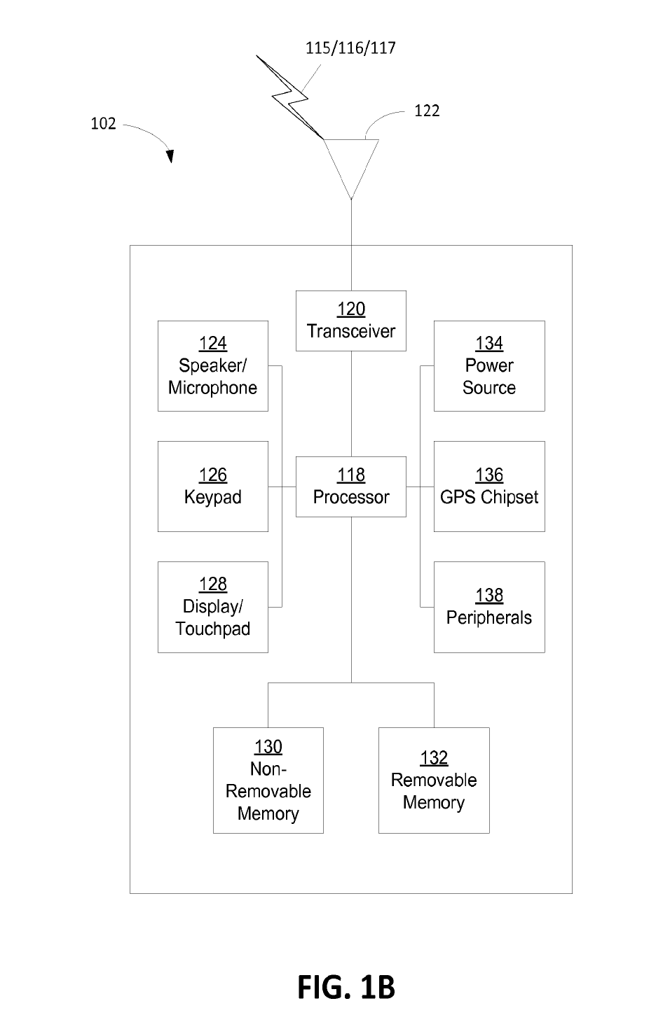

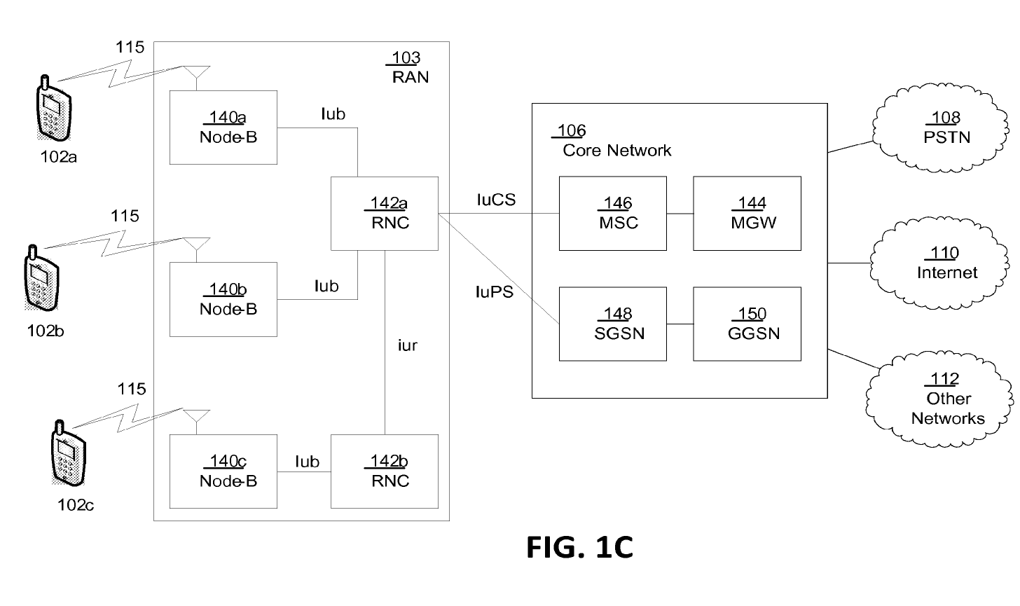

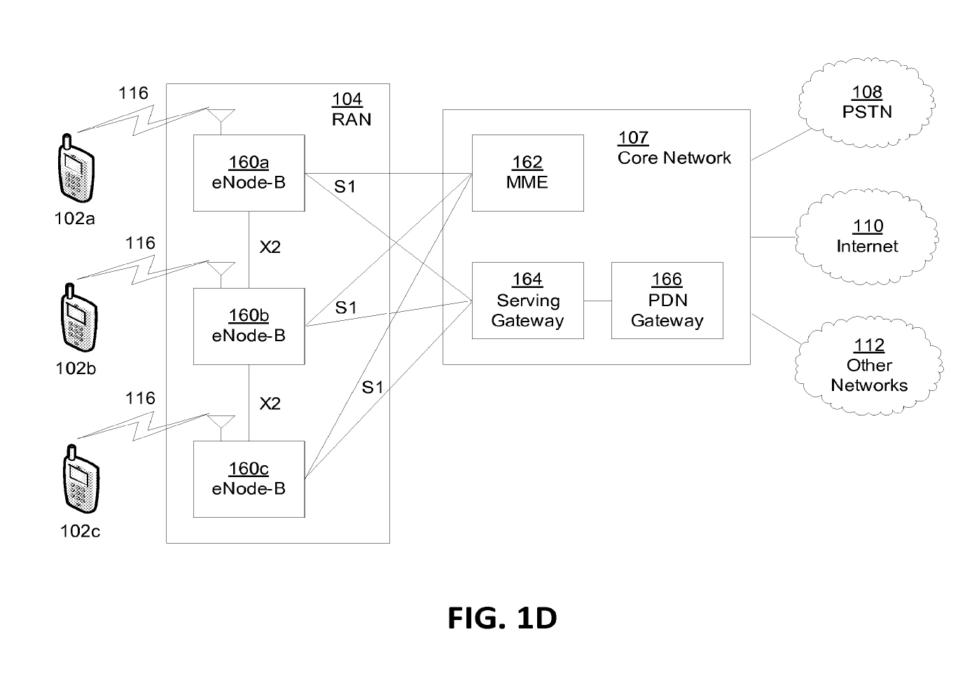

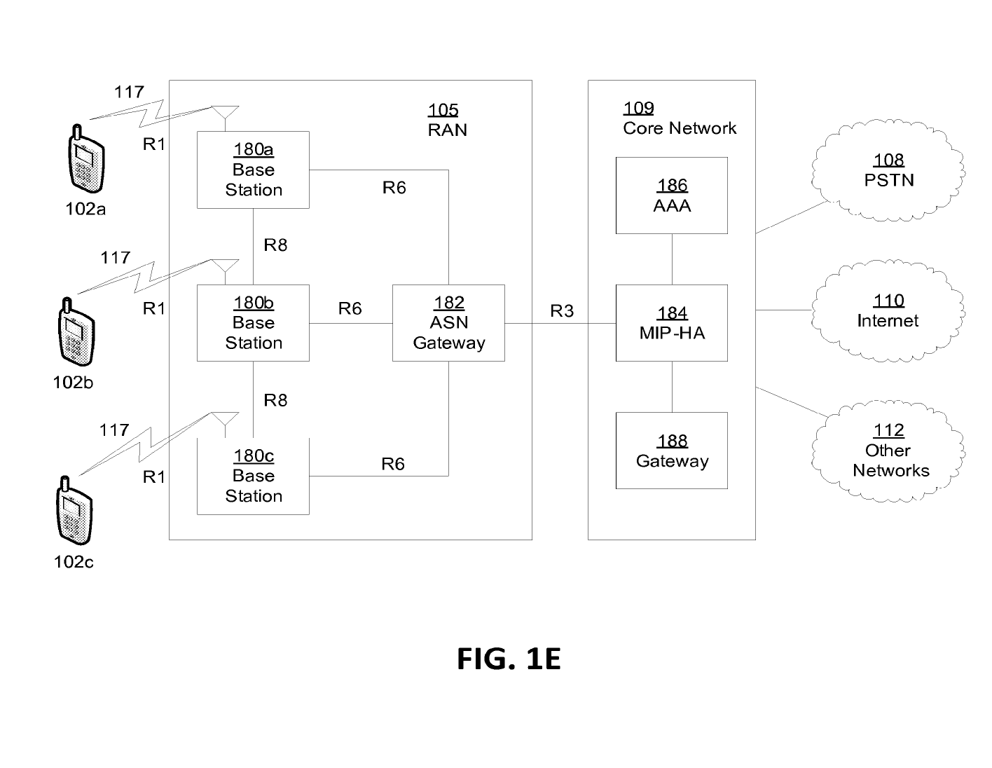

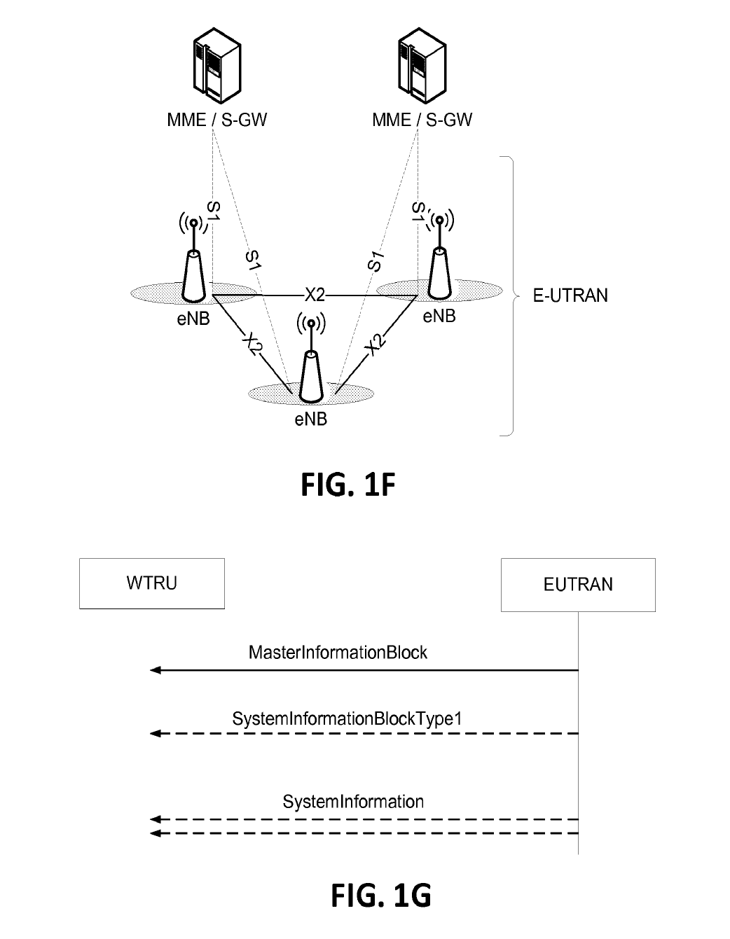

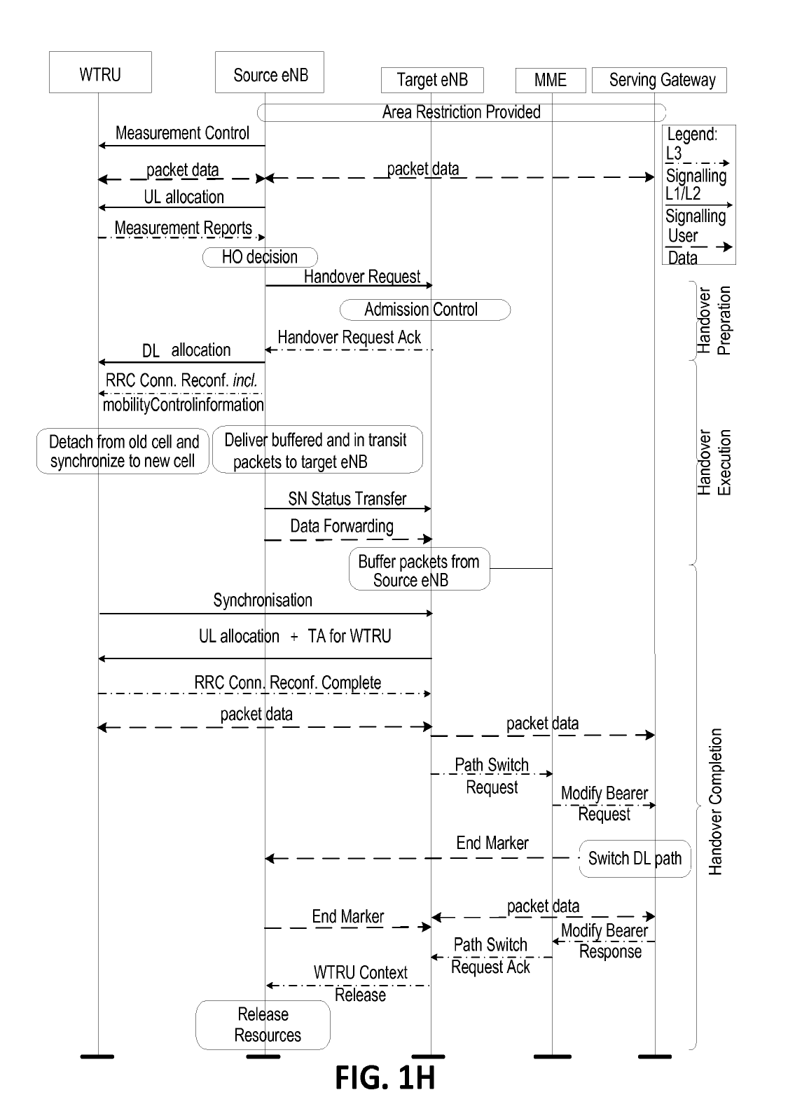

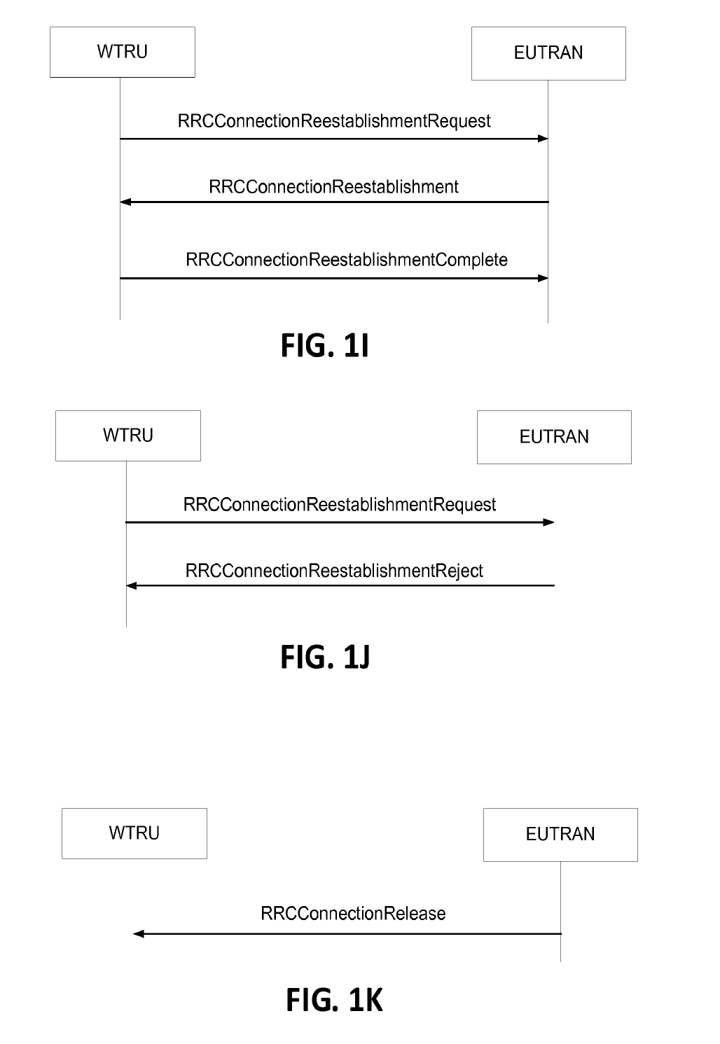

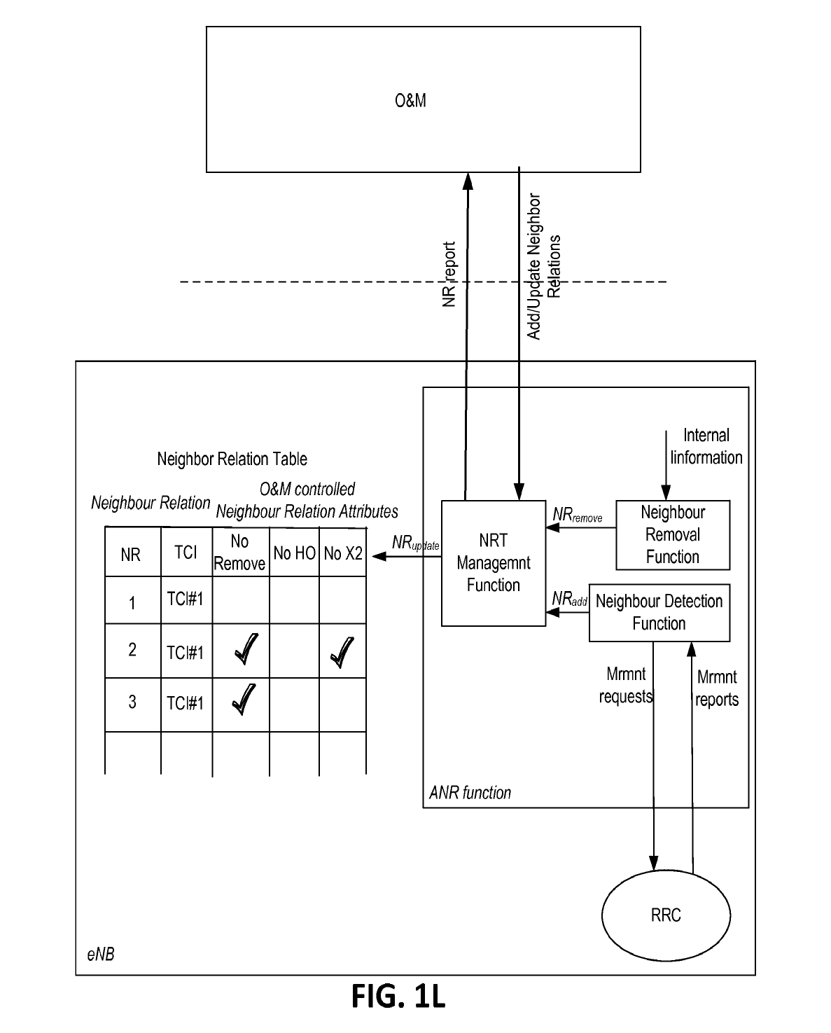

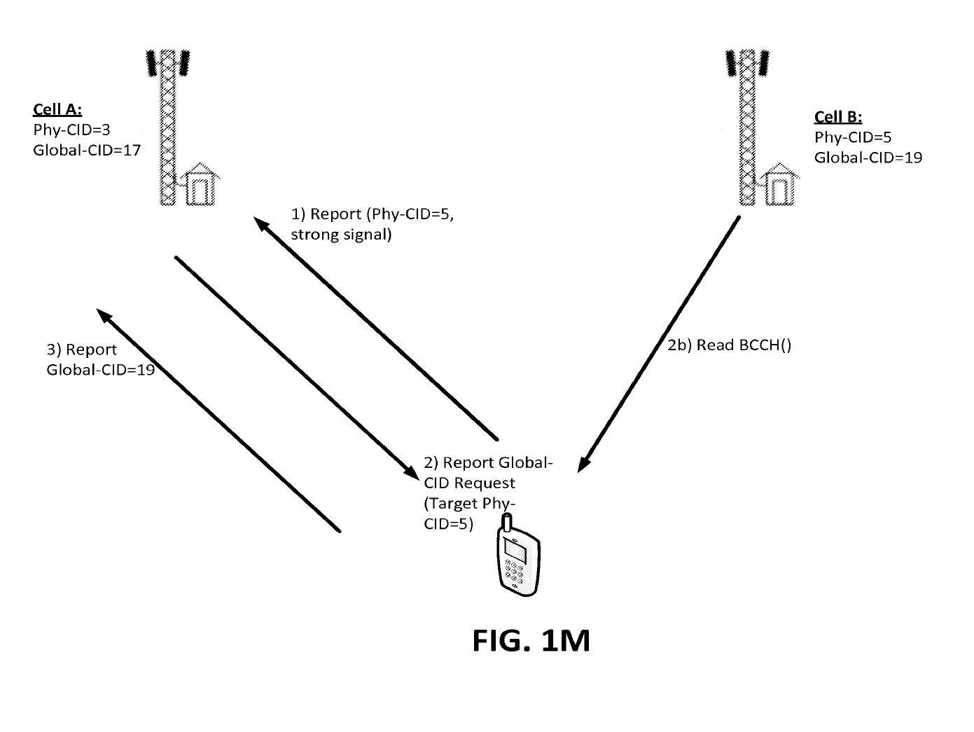

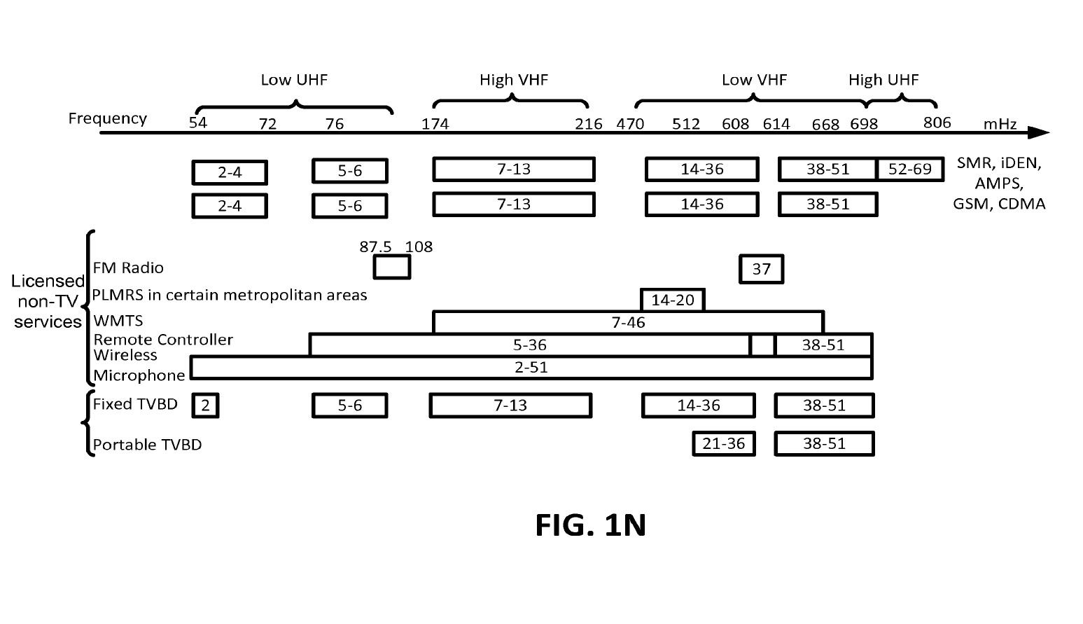

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers. i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c. 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a. 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 14b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro diversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a. 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b. 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S interface. The serving gateway 164 may generally route and forward user data packets to/from the WTRUs 102a, 102b. 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b. 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b. 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

An evolved universal terrestrial radio access network (E-UTRAN) may include eNBs providing an evolved universal terrestrial radio access (E-UTRA) user plane (e.g., a packet data convergence protocol (PDCP) layer, a radio link control (RLC) layer, a medium access control (MAC) layer, a physical (PHY) layer) and a control plane (e.g., a radio resource control (RRC) layer) protocol terminations towards a WTRU. The eNBs may be interconnected with each other by an X2 interface. The eNBs may be connected to an Evolved Packet Core (EPC) by an S1 interface, to a mobility management entity (MME) by an S1-MME interface, or to the serving gateway (S-GW) by an S1-U interface. The S1 interface may support a many-to-many relation between the MMEs and/or the S-GWs and the eNBs.

FIG. 1F illustrates an exemplary E-UTRAN architecture. A WTRU may be aware of the operating frequencies of the base station nodes in the network. An operator having a prior knowledge of these frequencies may include such information as part of the system information that may be broadcasted to the WTRUs. For example, in an LTE system, the system information may be broadcasted periodically in System Information Blocks (SIBs). Specific SIBs may be used to broadcast serving-cell and neighbor-cell information; e.g., cell identity, operating frequency, etc. FIG. 1G illustrates a diagram of an example system information acquisition procedure between a WTRU and an E-UTRA network. One of the SIBs may be a master information block (MIB), which may include a limited number of frequently transmitted parameters. An SIB may be a system information block Type 1 (SIB-I), which may include the scheduling information that indicates when the other SIBs may be transmitted (e.g., start times).

FIG. 1H illustrates an example of a mobility management entity (MME)/serving gateway handover. FIG. 1H, for example, illustrates a high level illustration of a handover (HO) scenario. As illustrated in FIG. 1H, the source evolved Node-B (eNB) may configure a WTRU measurement procedure. The WTRU may send a measurement report in accordance with the rules set by system information, specification, etc. The source eNB may make a handover decision based on the measurement report. The source eNB may issue a handover request message to a target eNB passing information to prepare the handover at the target eNB. Admission control may be performed by the target eNB, e.g., when the target eNB decides to admit the WTRU. The target eNB may prepare handover with L1/L2 and may send a handover request acknowledgement message to the source eNB. The handover request acknowledgement message may include a transparent container to be sent to the WTRU as a radio resource control (RRC) message. The source eNB may send a handover command to the WTRU.

The WTRU may detach from the source cell and synchronizes to the target cell and access the target cell, e.g., via an random access channel (RACH) following a contention-free procedure. A dedicated RACH preamble may be indicated in the handover command or following a contention-based RACH procedure if no dedicated RACH preamble was indicated in the handover command. The target eNB may send a random access response with uplink allocation and timing advance value for the WTRU. The WTRU may send a handover complete message to the target eNB. A normal packet data transfer may start between the WTRU and the target eNB.

A radio resource control (RRC) connection re-establishment may be used to recover from a temporary loss of the RRC connection. A WTRU in RRC_CONNECTED, for which security may have been activated, may initiate the RRC connection re-establishment to continue the RRC connection. The connection re-establishment may succeed, e.g., if the concerned cell is prepared (e.g., has a valid WTRU context). SRB1 operation may resume while the operation of other radio bearers may remain suspended, e.g., if the E-UTRAN accepts the re-establishment. The WTRU may not initiate the connection re-establishment and may move (e.g., directly move) to RRC_IDLE state, e.g., if AS security has not been activated.

The WTRU may initiate the RRC connection re-establishment, e.g., based on a condition. The condition may include one or more of a detection of radio link failure, a HO failure, mobility from E-UTRA failure, integrity check failure indication from lower layers, or an RRC connection reconfiguration failure. FIGS. 1I and 1J illustrate examples of the RRC connection re-establishment for successful and failure scenarios respectively. FIG. 1K illustrates an example where the connection re-establishment may release the RRC connection, which may include the release of the established radio bearers and radio resources.

As network deployments become denser, it may be more difficult for an operator to manually manage neighbor relations (NR). To relieve the operator from the burden of manually managing NRs, an automatic neighbor relation (ANR) function may be used. FIG. 1L illustrates an example of a high level block diagram of the ANR function that may reside in an eNB. The ANR function may manage the conceptual neighbor relation table (NRT). The Neighbor Detection Function (e.g., located within an ANR) may find new neighbors and add the newly found neighbors to the NRT. The ANR may include a neighbor removal function. The neighbor removal function may remove NRs (e.g., outdated NRs).

FIG. 1M provides an example of an ANR function. The ANR function may rely on cells broadcasting their identity on global level, E-UTRAN Cell Global Identifier (ECGI). As illustrated in FIG. 1M, the eNB of a serving cell (e.g., Cell A) may have an ANR function. The eNB, e.g., as a part of the normal call procedure, may instruct each of the WTRUs to perform measurements on neighbor cells. The eNB may use different policies for instructing the WTRU to perform measurements, and/or for instructing the WTRU as to when to report the measurements to the eNB. ECGI information may be reported by the WTRUs. The ECGI information may be processed by the ANR function and may be used to update the NRT.

Analog TV bands may include very high frequency (VHF) band and the ultra-high frequency (UHF) band. The VHF may be composed of the low VHF band operating from 54 MHz to 88 MHz (e.g., excluding 72 MHz to 76 MHz), and the high VHF band operating from 174 MHz to 216 MHz. The UHF band may be composed of the low UHF band operating from 470 MHz to 698 MHz, and the high UHF band operating from 698 MHz to 806 MHz.

Within the TV bands, a TV channel may be allotted 6 MHz of bandwidth. For example, channels 2 to 6 may be in the low VHF band; channels 7 to 13 may be in the high VHF band; channels 14-51 may be in the low UHF band; and/or channels 52 to 69 may be in the high UHF band.

In the United States, the Federal Communications Commission (FCC) set Jun. 12, 2009 as the deadline of replacing analog TV broadcasting by digital TV broadcasting. The digital TV channel definitions may be the same as the analog TV channel. The digital TV bands may use analog TV channels 2 to 51 (except 37), while the analog TV channels 52 to 69 may be used for new non-broadcast users. White Space (WS) may include a frequency allocated to a broadcasting service but not used locally. Television White Space (TVWS) may refer to the TV channels 2 to 51 (e.g., except 37).

There may be other licensed signals (e.g., other than TV signals) that may be transmitted on the TV bands. For example, channel 37 may be reserved for radio astronomy and Wireless Medical Telemetry Service (WMTS), where the WMTS may operate on a vacant TV channel, e.g., from 7 to 46. The Private Land Mobile Radio System (PLMRS) may use one or more channels (e.g., from 14 to 20) in certain metropolitan areas. Remote control devices may use a channels above channel 4, e.g., except channel 37. The starting frequency of FM channel 200 may be 87.9 MHz with partial overlapping on TV channel 6. The wireless microphone may use channels, e.g., channels 2 to 51 with bandwidth of 200 kHz. According to the recent FCC rule, the wireless microphone usage may be restricted to 2 pre-specified channels, and its operation on other channels may need pre-registry.

Furthermore, the FCC may allow unlicensed radio transmitters to operate on the TVWS expect channels 3, 4 and 37, as long as the minimum interfering is caused to the licensed radio transmissions. Hence, the operation of unlicensed radio transmitters may need to satisfy several restrictions.

Unlicensed TV Band Devices (TVBDs) may include: Fixed TVBD, Mode I portable (or personal) TVBD, Mode II portable (or personal) TVBD. The fixed TVBD and Mode II portable TVBDs may have geo-location and/or database access capability and may register to the TV band database. The access to a TV band may be obtained by querying the database for the allowed TV channels, so as to avoid the interference with digital TV signals and licensed signals transmitted on the TV bands.

The spectrum sensing may be considered as an add-on feature for TVBDs and may be used to guarantee very little interference may be caused to digital TV signals and licensed signals. A sensing-only TVBD may be allowed to operate on TVWS, e.g., if its access to TV band database is limited. Sensing-only TVBDs may, for example, meet the various requirements including. e.g., channel availability check time of 30 seconds, in-service monitoring of at least at an interval of 60 seconds, channel move time of 2 seconds, detection threshold for ATSC/NTSC signals of −114 dBm, detection threshold for wireless microphones of −107 dBm, etc.

FIG. 1N illustrates an example of a TV band spectrum usage. Fixed TVBDs may operate on channels, e.g., channels 2 to 51, except channels 3, 4, 37, but may not operate on the same or the first adjacent channel to a channel used by TV services. The maximum transmission power of fixed TVBD may be 1 W, with an antenna gain of, e.g., 6 dBi. The maximum Effective Isotropic Radiated Power (EIRP) may be 4 W.

Portable TVBD may operate on channels 21 to 51, except channel 37, but may not operate on the same channel used by TV services. The maximum transmission power of portable TVBD may be 100 mW or 40 mW if it is on the first adjacent channel to a channel used by TV services. A TVBD device's transmission power may not exceed 50 mW, e.g., if the TVBD device is a sensing-only device. Each of the TVBDs may have strict out-of-band emissions. The antenna (e.g., an outdoor antenna) height of fixed TVBD may be less than 30 meters, while there may be no such limitation on the antenna height for portable TVBD.

FCC regulations may provide a collective use model, whereby an unlimited number of independent users and/or devices may access the spectrum at the same time and in the same area under a well-defined set of conditions. An advisory group of the European Commission the radio spectrum policy group (RSPG) has considered that white space and other spectrum may be shared through licensed shared access (LSA). LSA may be based on authorized shared access (ASA). LSA is a regulatory policy or licensing regime whereby a limited number of licensees in a frequency band that is allocated or owned by a primary incumbent user may use the band in a non-interfering basis. In LSA, the additional users or licensees may be allowed to use the spectrum in accordance with sharing rules included in the rights of use of the spectrum granted to the licensees, which may allow the licensees to provide a certain level of QoS. The advantage of LSA may be that the number of users allocated to use the spectrum may be limited, and there may be more regulatory control associated with the use of the spectrum. The regulator may know who is licensed to operate in a given band, and may be well positioned to effectively deal with any cases of interference that may arise to the incumbent user. The regulator may be in a position to ensure that each licensee receives the QoS that it may have been guaranteed at the time the license may be issued (e.g., under the terms of a particular license).

An LSA system may pool resources that may belong to different primary services or spectrum owners. For example, multiple cellular operators may be interested in licensing some of their spectrum during periods of low network load and may use the LSA to allow this spectrum to be leased to a fixed number of other (e.g., secondary) users or licensees.

The 2300-2400 MHz band has been allocated to mobile service globally by the ITU and is identified for use by time division duplex (TDD) technologies. The technologies to make use of LSA may be based on TDD. Cloud spectrum sharing (CSS) may be provided. A free spectrum may be pooled together to create a single set of resources that may be allocated dynamically (e.g., on a very short time period) to one or more systems that may request a temporary license to use the spectrum.

A number of spectrum sharing possibilities may be identified for LSA for both the commercial domain, as well as military and public safety domains. The Joint Research Center (JRC) has proposed spectrum sharing possibilities between domains in various fields including military, which may be the owner of the spectrum and may lease the spectrum to public safety, the public safety, which may be the owner of the spectrum and may lease the spectrum to critical infrastructure parties, public safety, which may lease the spectrum to commercial network operators, and/or commercial networks, which may lease the spectrum to specific businesses.

Dynamic transfer of exclusive rights, for example, between the commercial and public safety domains may be provided and may be envisioned for various use cases. For example, a spectrum may be owned by a public safety organization to be used for emergency situations and public safety routines. When no emergency situation occurs, the public safety organization may lease the spectrum to a commercial operator who may benefit from additional spectrum during peak hours. The operator may be an existing operator who may use its existing infrastructure in order to make use of the spectrum. A Mobile Virtual Network Operator (MVNO) may make use of the infrastructure provided by the public safety organization. A spectrum that may be owned by an operator may lease the spectrum to a public safety organization that may require additional bandwidth. e.g., during certain emergency events or for duration of a planned event.

Evacuation of a secondary user or system may include evacuation of one or more secondary user base stations or access points, and/or evacuation of one or more secondary user WTRUs. For example, a Long Term Evolution (LTE) system may use a channel as an LSA licensee. When the incumbent user (e.g., the LSA incumbent user or the primary user (PU)) may want to re-gain access to its spectrum (e.g., a shared spectrum channel), the secondary user (e.g., an LTE system acting as the LSA licensee) may evacuate the channel. An LTE system may use unlicensed spectrum such as Television White Space (TVWS) as a secondary user. The incumbent user for a shared spectrum channel (e.g., DTV) may return to the channel and may force the secondary user (e.g., the LTE system) to evacuate the channel. The WTRUs associated with the LTE system in a region (e.g., a localized region) may be evacuated.

The system evacuation may include the secondary user (e.g., the secondary user base station) notifying the arrival and/or eventual arrival of the incumbent user or the PU on the shared spectrum channel, and/or the secondary user base station signaling the WTRUs under its control to evacuate the channel. A secondary user (e.g., a secondary user WTRU) may detect the incumbent user and may report the detection. The evacuation of the channel may include. e.g., a handover (e.g., via RACH), a connection re-establishment, and/or a connection release.

A secondary user base station (e.g., a LTE eNB) may receive an evacuation notification from the incumbent user. For example, the incumbent user may be aware (e.g., directly or indirectly) of the secondary user to which the incumbent user may be licensing the use of its spectrum or use its spectrum in a secondary fashion. The incumbent user may include a PU, and the two terms may be used interchangeably herein. The incumbent user may include, e.g., an LSA incumbent system, a radar system, a DTV system, a wireless microphone system, or the like that may have priority use of a shared spectrum. The secondary user (SU) may include a licensee such as an LSA licensee, a cellular network base station such as an LTE base station (e.g., an eNode B) and associated WTRUs, an IEEE 802.11 based access point (AP) and associated stations, or the like that may use the shared spectrum when the incumbent user is not using the spectrum. The PU may have some knowledge of the SU that may be using the shared channel.

The secondary user base station may be informed of the need to perform a system evacuation. For example, the secondary user base station may learn of the need for evacuation at a fixed time instant. The secondary user base station may learn of the need for evacuation through messaging or signaling sent directly by the PU (e.g., an LSA incumbent). The secondary user base station may learn of the need for evacuation through a database or broker etc.

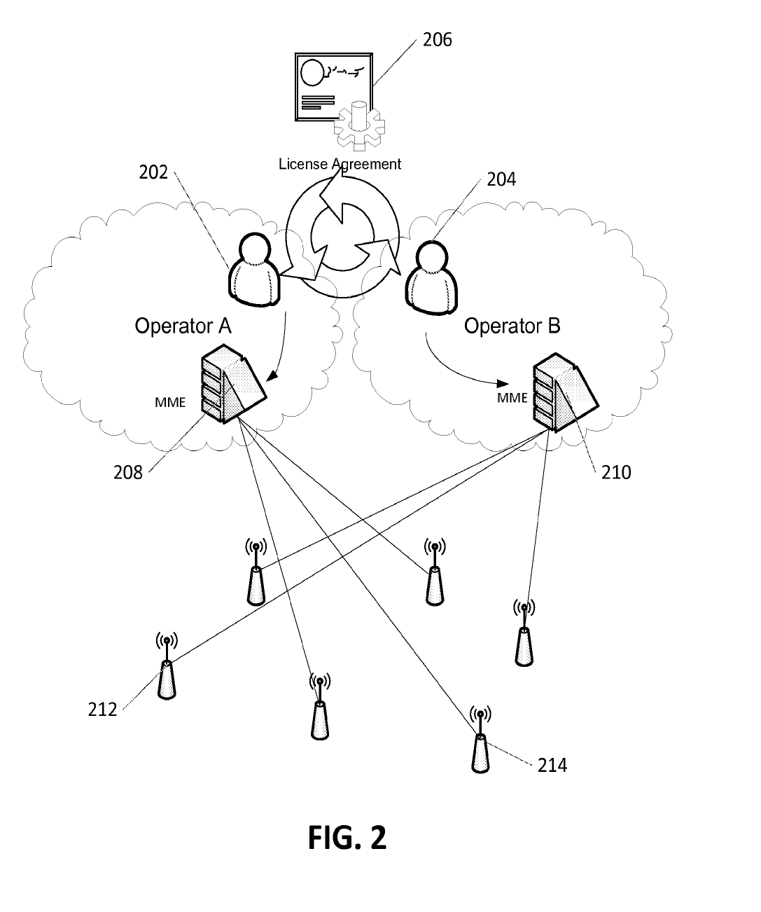

The secondary user base station may be aware or may be notified at a specific time instant of the need to evacuate the channel. The time instant may be based on an agreement between the incumbent operator (e.g., an LSA incumbent operator) and the secondary user operator (e.g., an LSA licensee operator). For example, the agreement may be a one-time-use agreement that may be negotiated prior to the time when the sublicense may be granted. The agreement may include a time that may indicate when the sublicense may be valid (e.g., start time) and/or a time that may indicate when the sublicense may expire. FIG. 2 illustrates an example architecture that may be used for evacuation at a time instant (e.g., known time instant). As illustrated in FIG. 2, the operators (e.g., the operator A 202 and the operator B 204) may negotiate a license agreement 206. The license agreement 206 may include the start time and/or the expiry time of the license.

As illustrated in FIG. 2, the base station 212 or the base station 214 may be aware of the expiry time of license, or may be made aware of it by messaging sent by a control or a management entity such as the MME (e.g., MME 208 and/or MME 210) which may be aware of the expiry time). At the expiry time, the MME (e.g., MME 208) may initiate evacuation of the attached WTRUs. The license agreement may include an agreement negotiated between the two operators, e.g., the secondary user (e.g., an LSA licensee), and the incumbent user (e.g., an LSA incumbent), with a potential third party mediator involved. The license agreement may include a request form that may be filled out manually by an employee of the secondary user operator which interactively may reserve the spectrum for use at a specific time (e.g., while showing the available spectrum channels and time for each).

The license agreement 206 may allow periodic use of the spectrum (e.g., a shared spectrum channel) by the secondary user base station 204 over a defined period and duration that may be set forth in the same ways as above. A secondary user base station may be aware of the need to evacuate the channel being used, or may be notified of this by a management entity such as the MME 210, e.g., prior to the expiry of each pre-defined usage period.

The LSA incumbent and/or the LSA licensee may be LTE systems. Protocols (e.g., LTE protocols) may be used to signal to the LSA licensee base station, the need for evacuation of a channel or band. The need for an LSA incumbent to regain access to its spectrum may depend on the function of the network, and/or may be triggered by a network management entity of that LTE network (e.g., the need to provide additional capacity for peak rate hours or large network load). The network management entity may include a broker and/or a database. The broker and/or the database may be part of the LSA licensee network, may be part of the LSA incumbent network, and/or may be outside of the networks. The need for evacuation may be triggered by an external event (e.g., activation of a dormant or unused network due to an emergency situation). The base station of the LSA incumbent system may be notified of the need to activate a cell on spectrum it may have owned and in turn, may signal the eNB of the LSA licensee. A common management entity or separate management entities responsible for each network may notify the incumbent and licensee base stations.

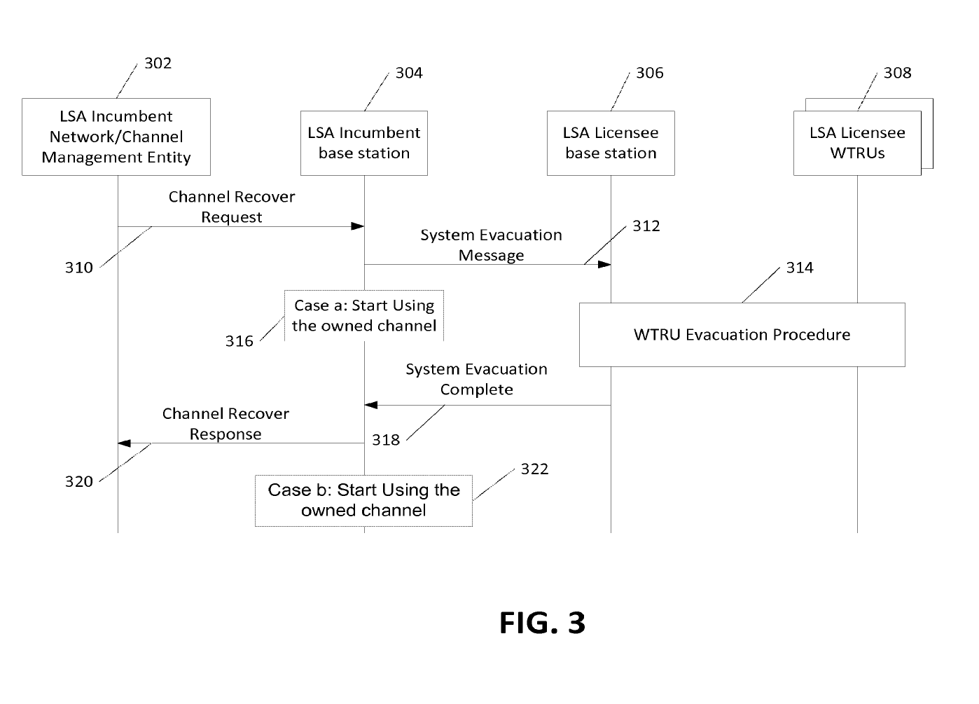

FIG. 3 illustrates an evacuation, e.g., triggered by a signaling from the LSA incumbent. As illustrated in FIG. 3, at 310 a channel recover request may be triggered, e.g., by the network management/channel management entity of the LSA incumbent network 302 to the LSA incumbent base station 304. The channel recover request may be triggered by other means. An entity within the LSA incumbent base station 304 may be responsible for this message. For example, the channel management entity that may decide to recover an LSA channel may reside within the LSA incumbent base station 304.

The X2 interface may be used for communication between the LSA incumbent base station 304 and the LSA licensee base station 306. The X2 interface may provide base station channel evacuation coordination between the LSA incumbent base station 304 and the LSA licensee base station 306. An LSA license agreement may indicate a need for the LSA licensee base station 306 and the LSA incumbent base station 304 to communicate over the X2 interface.

As illustrated in FIG. 3, at 312, the LSA incumbent base station 304 may send a system evacuation message to the LSA licensee base station 306, e.g., over the X2 interface. At 314, the system evacuation message may trigger evacuation of WTRUs 308 (e.g., the WTRUs using a sublicensed LSA channel). Once the LSA licensee base station 306 has completed the WTRU evacuation procedure 314, at 318 the LSA licensee 306 may send an acknowledgement message (e.g., a system evacuation complete message). The LSA incumbent base station 304 may start using the owned channel, and at 320, may send a channel recover response to the channel management entity to acknowledge the recovery of the sublicensed LSA channel.

As illustrated by an example in the FIG. 3, at 316 the LSA incumbent base station 304 may start using the owned channel immediately following the transmission of the System Evacuation Message at 312 (e.g., in the case where the system evacuation complete message may not be sent by the licensee). At 322, the LSA incumbent base station 304 may start using the owned channel upon receiving the system evacuation complete message at 318.

The system evacuation message and the system evacuation complete message may include an X2AP (X2 Application Protocol) message, when the X2 interface is employed between the LSA incumbent base station and the LSA licensee base station. In addition to the evacuation and confirmation messages, the messages may include one or more of an identification of the sublicensed LSA channel to be evacuated, a time limit or delay for evacuation, or information about alternate channels that may be used as a replacement. The system evacuation complete message may confirm the agreement to use the replacement channel that was suggested.

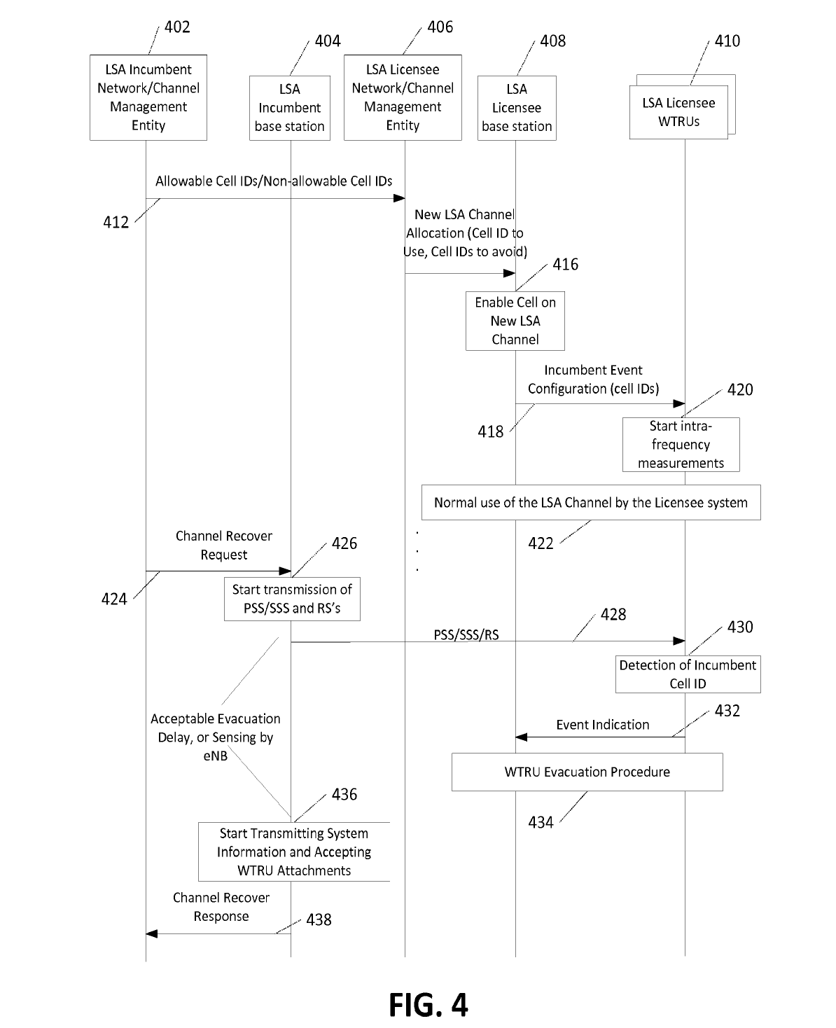

FIG. 4 illustrates an example of sending the system evacuation message using e.g., the synchronization channel (SCH) and/or the reference signal (RS) transmission. The synchronization symbols may be detected by a WTRU that may be configured for intra-frequency measurements. The detection of these symbols may be indicated to the base station by the WTRU that may perform the detection. The detection of these symbols may be sent in the form of a triggered measurement event. A triggered measurement event may initiate a WTRU evacuation procedure for the LSA licensee system.

As illustrated in FIG. 4, at 412, an LSA incumbent network/channel management entity 402 of the LSA incumbent base station 404 may send the identities of the allowable and/or non-allowable cell IDs to the LSA licensee network/channel management entity 406 of the licensee base station 408. At 416, the LSA licensee base station 408 may enable a cell on the LSA channel. This information may allow the LSA licensee to operate on the channel without interference to other incumbent eNBs active in neighboring channels or neighboring areas, and may avoid potential interference between the incumbent and licensee during the time when the incumbent may decide to force evacuation of the channel by transmitting SCH.

At 418, the LSA licensee base station 408 may send the incumbent event configuration (e.g., through RRC messaging) to its associated WTRU(s) 410. The event configuration may include the cell ID or cell IDs that the incumbent system may use. At 420, the WTRUs may start intra-frequency measurements based on the received incumbent event configuration and may start to monitor the LSA channel. Intra-frequency measurements may be configured in the Licensee eNB and/or WTRUs to search for and detect other cells. At 422, the LSA licensee system may start using the LSA channel.

At 424, LSA incumbent network/channel management entity 402 of the LSA incumbent base station 404 may send a channel recover request 424 to the LSA incumbent base station 404. At 426, the LSA incumbent eNB 404 may start transmission of the primary synchronization signals (PSSs) and/or the secondary synchronization signal (SSSs) and RSs 428. At 430, a secondary user WTRU such as one of the LSA licensee WTRUs 410 may detect the SCH of the LSA incumbent base station, which may include the incumbent cell ID. The one of the WTRUs 410 may detect an active incumbent base station on the LSA channel. At 432, the licensee WTRU may generate and send a detection message (e.g., an RRC message) to the LSA licensee base station 408 indicating the event. The LSA licensee base station 408 may treat the message indicating the event in the same manner as the system evacuation message. The LSA licensee base station 408 in response to the message indicating the event may initiate WTRU evacuation procedure 434 (e.g., as described herein).

The LSA incumbent base station 404 may start using the sublicensed LSA channel immediately when SCH and reference symbols are transmitted (e.g., as described herein at 316 of FIG. 3). The base station may effectively start using the owned channel upon determining that the LSA Licensee has evacuated the channel (e.g., as described herein at 322 of FIG. 3). This may be achieved by transmitting the SCH and reference symbols (e.g., without transmission of any system information that allows a WTRU to camp on the cell). The incumbent eNB 404 may perform sensing of the channel to determine when the LSA licensee base station 408 has evacuated the channel. The incumbent base station 404 may wait for an acceptable interval of delay, where LSA sublicensed channel may be guaranteed to be made available (e.g., based on a strict requirement for evacuation time). During the evacuation time, the LSA licensee base station may receive the System Evacuation Message (e.g., via an event that was triggered by a WTRU), and may complete the WTRU evacuation. At 436, the Incumbent base station 404 may start to transmit system information and effectively start using the channel and/or accepting WTRU attachments. At 438, the incumbent base station 404 may send a channel recover response to the channel management entity 402 when the transmission of the system information has begun.

The incumbent base station 404 may turn on the SCH without turning on the RSs. This may result in a minimal amount of interference on the licensee system while the system evacuation may be taking place. The RSs may be turned on when the base station may start to transmit the system information (e.g., after the expiry of the acceptable evacuation delay, or when determining that sensing indicates that licensee evacuation has completed). The LSA licensee base station may perform measurement and detection of the SCH of the LSA incumbent base station. Such a setup may be advantageous, for example, in the case where there are no attached WTRUs or no WTRUs which are capable of performing measurements. The base station of the LSA licensee system may be made aware of the cell ID to be monitored (e.g., corresponding to the cell ID of the incumbent) prior to the use of the sublicensed LSA channel. The LSA licensee base station may monitor the LSA channel for the SCH of the incumbent and may trigger a WTRU evacuation if it detects the LSA channel that may belong to the LSA incumbent base station.

The System Evacuation Message may take the form of normal system information transmitted by the incumbent system. When an incumbent system may wish to regain access to the channel, it may transmit SCH and system information in the form of SIBs. The PLMN ID of the incumbent operator may be used as the indication to trigger the system evacuation at the LSA licensee system. The LSA licensee base station may be made aware of the PLMN ID of the LSA incumbent network, through messaging or pre-configuration. The LSA licensee base station may send a measurement event to its WTRUs (e.g., via RRC messaging) to indicate to the WTRUs to perform (e.g., periodically perform) a PLMN search on the LSA channel. The WTRUs may perform the search for other cells and read SIB I to retrieve the PLMN ID of the other cells. If a WTRU performs a PLMN search and finds the PLMN ID of the LSA incumbent system, the WTRU may trigger an event and inform the base station of the event. The evacuation may be started by the licensee eNB in response to the event. The licensee base station may perform the periodic PLMN search, for example, when there are no attached WTRUs on the eNB. The WTRUs and base station may perform simultaneous PLMN search.

Further, the system evacuation message may take the form of a special RACH message. The message may be sent by the incumbent eNB to the licensee base station. The use of a RACH message, e.g., a random access preamble, may allow reliable transmission of the System Evacuation Message despite the lack of exact synchronization between the two base stations.

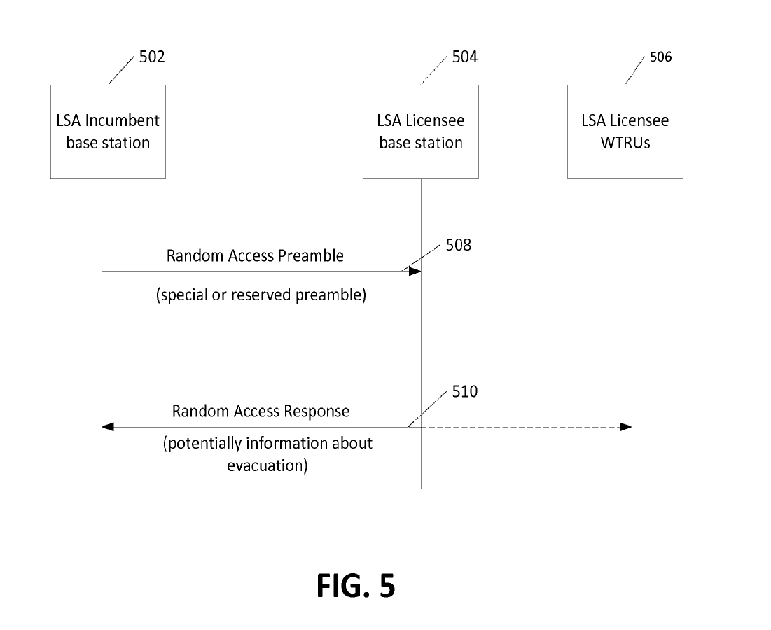

FIG. 5 illustrates an example of RACH procedure that may be used to support system evacuation in LTE. The procedure may implement the system evacuation message and the system evacuation complete message as described herein (e.g., as illustrated in FIG. 3). For example, the incumbent eNB may listen to and/or decode the system information from the licensee eNB, e.g., prior to starting transmission and operation of a cell on the LSA frequency. The incumbent eNB may be preconfigured with system information. Following the acquisition of the system information, the incumbent base station may transmit a RACH message during the RACH occasions specified by the licensee base station system information. This RACH message may indicate to a licensee base station that it originates from the incumbent system and not a WTRU that is trying to attach to the network. For example, a reserved or agreed upon WTRU ID may be used in the RACH message to signal this information.

As illustrated in FIG. 5, at 508, an LSA incumbent base station 502 may send a random access preamble to an LSA licensee base station 504. The random access preamble may include a special, a reserved, and/or agreed-upon preamble that may signal the intent of the LSA incumbent to recover its owned channel. At 510, the LSA licensee base station 504 may send a random access response to confirm the reception by the LSA licensee base station 504 of the need to evacuate the channel. The random access response may be sent on the downlink shared channel (DL-SCH) and may be indicated on the physical downlink control channel (PDCCH), e.g., using the random access-radio network temporary identifier (RA-RNTI), with the special preamble sent in the first step. If there is no risk for contention (e.g., if there is one LSA incumbent for a given channel), the contention resolution may not be needed. Contention resolution may be performed, e.g., when a plurality of LSA incumbents is associated with a channel.

The random access response may be used by secondary user WTRUs such as the LSA licensee WTRUs 506 to detect the need to evacuate the channel (and hence may be used as a WTRU evacuation). The information in a random access response message (e.g., a traditional random access message) may be replaced with information about the evacuation itself (e.g., delay for evacuation, exact time of evacuation, identification of alternate channels, etc.).

The terminal identification (e.g., as using in RACH) may be replaced by determination of an alternate channel identification. The LSA incumbent base station may provide the base station licensee eNB information about alternate channels that may be used under the same LSA license agreement following the evacuation.

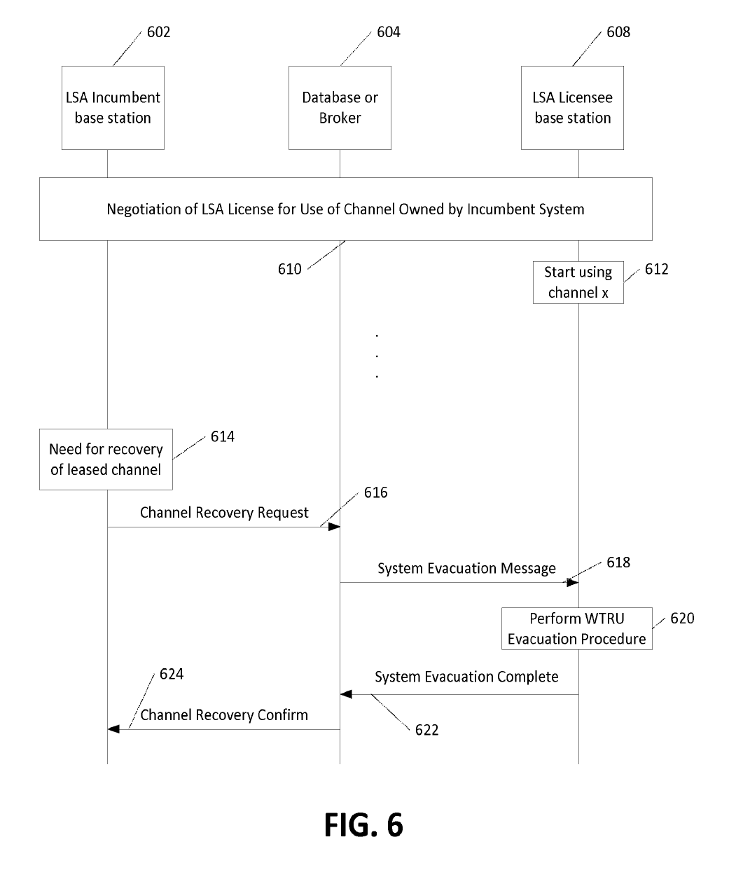

Evacuation may be triggered by a database or a broker. An LSA licensee may subscribe to the services of a database or broker that may inform the licensee of the need to evacuate a channel. The database or broker may be responsible for allocation of the channels that may be made available by the LSA incumbent. FIG. 6 illustrates an example where a database or a broker 604 may notify the LSA licensee base station 608 of the need to evacuate an LSA channel. This information exchange may take place between the database and/or the broker 604 and the MMEs of the LSA licensee base station 608 and the incumbent base station 602. At 610, the LSA incumbent base station 602, the database or broker 604 and the LSA licensee 608 may negotiate the LSA license for use of an LSA channel owned by the LSA incumbent system. At 612, the LSA licensee base station 608 may start using the LSA channel based on the negotiated license. At 614, the LSA incumbent base station 602 may need to re-claim its leased LSA channel. At 616, the LSA incumbent base station may send a channel recovery request to the database or the broker 604 indicating the need for recovery of the leased channel. At 618, the database or the broker 604 may send a system evacuation message to a secondary user base station such as the LSA licensee base station 608. At 620, the LSA licensee base station 608 may initiate and perform evacuation of the leased LSA channel. At 622, the LSA licensee base station 608 may send a system evacuation complete message to the database or the broker 604. At 624, the LSA incumbent base station 602 may receive a channel recovery confirmation from the database or the broker 604. The LSA incumbent base station 602 may regain access to its LSA channel as described herein.

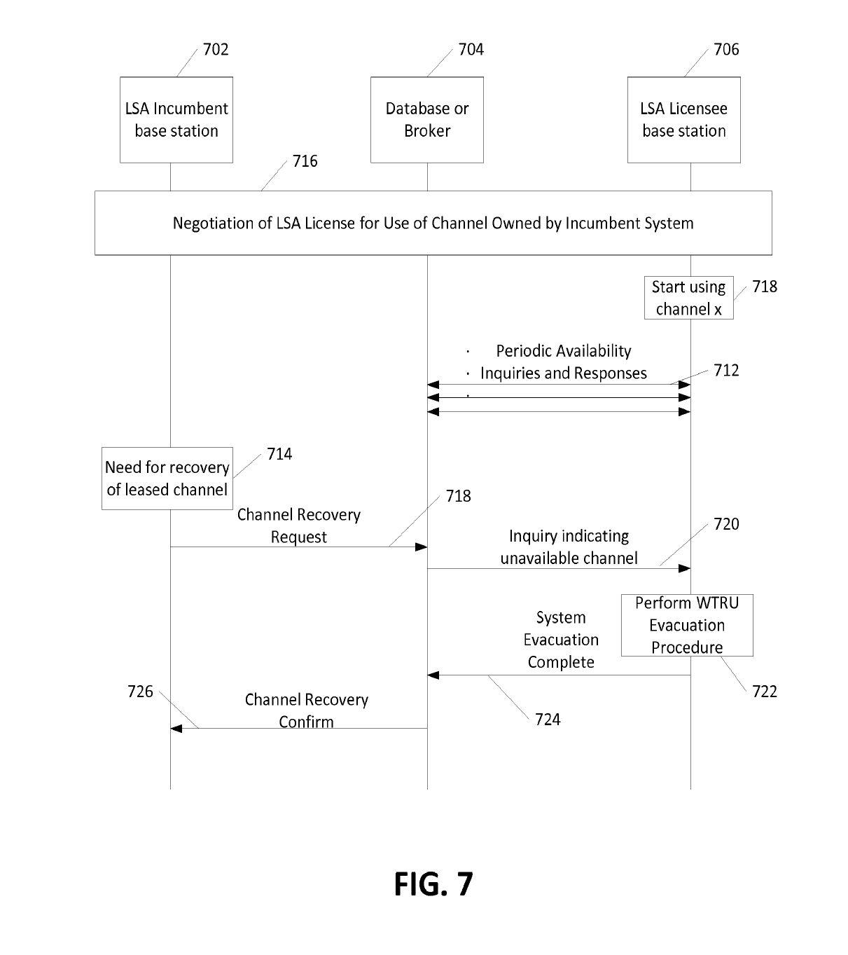

FIG. 7 illustrates an example where a database or a broker 704 may notify the LSA licensee base station 706 of the need to evacuate an LSA channel. As illustrated by example in FIG. 7, at 716, the LSA incumbent base station 702, the database or broker 704 and the LSA licensee 706 may negotiate the LSA license for use of an LSA channel owned by the LSA incumbent system. At 718, the LSA licensee base station 706 may start using the LSA channel based on the negotiated license. At 712, the LSA licensee base station 706 may periodically check the status of the currently used channel with the broker or database in order to determine whether evacuation is needed. The period with which the database or broker 704 may be consulted by the LSA licensee base station 706 may be defined as part of the LSA license agreement that may be established between the LSA licensee base station 706, the LSA incumbent base station 702, and the LSA broker and/or database 704. This information exchange may take place between the database and/or the broker 704 and the MMEs of the LSA licensee base station 706 and the incumbent base station 702. At 714, the LSA licensee MME may indicate to the affected base stations that a channel is required to be evacuated or replaced with another channel. The database or the broker 704 may manage one or more LSA licenses for one or more LSA incumbents in a given area. The database or the broker check may include the ID of the license or licensee in order to identify it. At 714, the LSA incumbent base station 602 may need to re-claim its leased LSA channel. At 718, the LSA incumbent base station may send a channel recovery request to the database or the broker 704 indicating the need for recovery of the leased channel. At 720, the database or the broker 704 may initiate a system evacuation message to the LSA licensee base station 706. At 722, the LSA licensee base station 706 may initiate and perform evacuation of the leased LSA channel. At 724, the LSA licensee base station 706 may send a system evacuation complete message to the database or the broker 704. At 726, the LSA incumbent base station 702 may receive a channel recovery confirmation from the database or the broker 704. The LSA incumbent base station 702 may regain access to its LSA channel.

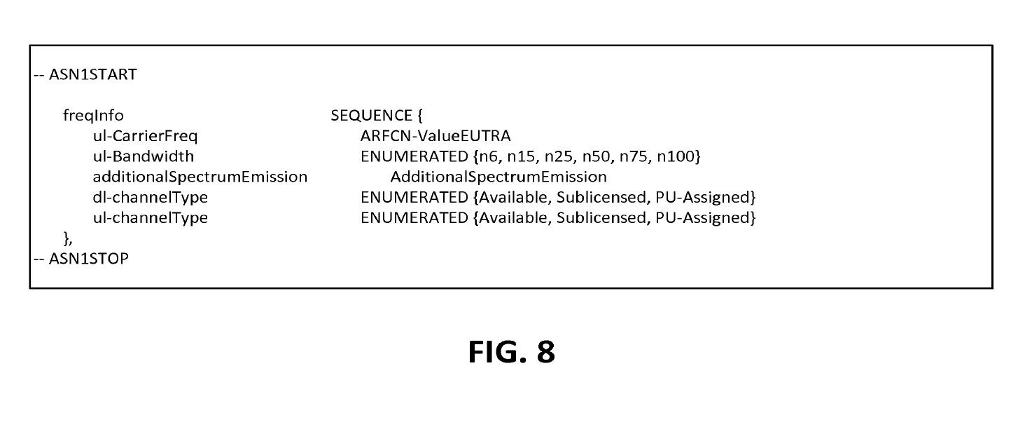

The channel evacuation of one or more WTRUs that may be served by a base station may be performed by a WTRU detecting and reporting the arrival of a PU. Signaling of a channel type to the WTRU may be used to control the WTRU behavior when operating on the channel. FIG. 8 illustrates an example information element that may be used to signal the channel type to the WTRU, e.g., via SIB2. The information element may include a downlink channel type, and/or an uplink channel type. The downlink channel type or the uplink channel type may indicate whether the channel is an available channel, a sublicensed channel or a PU-assigned channel. The WTRU may change its mode of operation based on the channel type. For example, the WTRU may determine whether to perform PU detection based on the channel type. WTRU behavior such as PU detection, reporting, and/or execution of channel evacuation may be conditioned on the channel type. For example, when operating on an available channel, legacy procedures may be used. When operating on an alternate type, such as sublicensed or PU-assigned, PU detection, detection reporting and channel evacuation may be performed. The PU-assigned channel may be a channel assigned to a PU. The PU may require a secondary user to leave the channel, if the PU is detected.

Dedicated signaling may be used to signal the channel type and/or enable the execution of various procedures. For example, the enhanced RRC measurement configuration and reporting may be used to enable/disable PU detection reporting functionality. RRC measurement configuration and reporting may be used for PU detection reporting to the eNB. The measurement procedure may define measurement quantities and reporting events to enable PU detection and reporting.

One or more PU detection reporting may be provided. The various PU detection reporting implementations may include one or more of a medium access control, control element (MAC CE) based detection, a Physical Uplink Control Channel (PUCCH) based detection, or a random access channel (RACH) based PU detection reporting, etc.

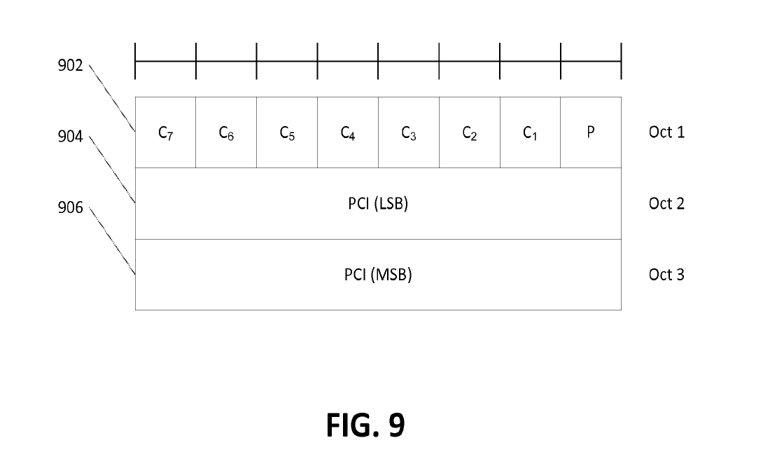

MAC CE based detection reporting may be used to enable low latency PU detection reporting to the eNB. FIG. 9 illustrates an example of an uplink primary user (UL-PU) Detection MAC Control Element. The UL PU Detection MAC control element may be identified by a MAC Protocol Data Unit (MAC PDU) sub header with a logical channel ID (LCID). The sub header may be chosen from the set of reserved uplink shared-channel logical channel IDs (UL-SCH LCIDS). The sub header may have a variable size and may include 1 or 3 octets. As illustrated in FIG. 9, the first octet 902 may have seven C-fields (e.g., C1-C7) and one P-field (e.g., P1). The second octet 904 and third octet 906 may include least significant bits (LSB) and most significant bits (MSB) of Physical Cell Identity (PCI) field respectively.

In a first octet Oct 1 902 of the PU Detection MAC control element, for example, if there is an Secondary Serving Cell (SCell) configured with SCellIndex i, this field may indicate that the PU detection status of the channel used by the SCell with SCellIndex i. The eNB, otherwise, may ignore the Cᵢ field. The Cᵢ field may be set to 1 to indicate that a PU was detected on the channel used by the SCell with SCellIndex i. The Cᵢ field may be set to 0 to indicate that a PU was not detected on channel used by the SCell with SCellIndex i.

A first octet Oct 1 902 may indicate the PU detection status of the Primary Cell (PCell). The P field of the Oct 1 902 may be set to 1 to indicate that a PU was detected on the channel used by the PCell. The P field may be set to 0 to indicate that a PU was not detected on the channel used by PCell.

The second octet Oct 2 904, and the third octet Oct 3 906 may indicate the PCI of the best cell measured by the WTRU. The second octet Oct 2 904 may carry the LSB of the PCI. The third octet Oct 3 906 may carry MSB of the PCI. The PCI information in octets Oct 2 904 and the Oct 3 906 may be included in the case when a PU may be detected on the channel used by the PCell. The length of the field is 16 bits.

A WTRU may use PUCCH to send PU detection indication to the eNB. The Scheduling Request (SR) may use PUCCH format 1 to indicate the request for resources. WTRU may use PUCCH format 1 to send PU detection indication to the eNB. The transmission of a PU detection indication to the eNB may be achieved, for example, by reserving a subset of the available SR PUCCH resources. The identification of the resource index for the SR PUCCH resources may be provided, for example, as listed in table 10.1.5-1 of 3GPP TS 36.213 v10.5.0, Physical Layer procedures (Release 10). The identification of the resource index may be controlled by an SR configuration index (e.g., sr-ConfigIndex) parameter, e.g., as provided by higher layers. An additional PU configuration index (e.g., pu-ConfigIndex) may be used to identify the subset of SR resources that may be used to signal PU detection. For example, an sr-ConfigIndex of 0-4 may indicate a periodicity of 5 ms for the SR resources and an offset provided by the configuration index. A pu-ConfigIndex may, for example, be defined as in the table 10.1.5-1 stated above. The pu-ConfigIndex may indicate the periodicity of the SR resources that may be used for PU detection. The PU detection resources in the example case may come at an interval of 10 ms, in which case, half of the SR resources may be used for PU detection indication, while the other half may continue to be used for SR. The pu-ConfigIndex and associated table may identify (e.g., distinctly identify) the PU, and the SR resources, and may be based on the frame number modulo k, where k may be related to the pu-ConfigIndex.

The WTRU signalling of PU detection may be based on the sr-ConfigIndex, where the WTRU may identify the available SR resources that it may use in the PUCCH for SR and PU detection indication. The WTRU PU detection may be based on the pu-ConfigIndex. The WTRU may identify a subset of the SR resources that may be reserved for PU detection indication (while the remainder may be used for SR). If a PU is detected by a WTRU, the WTRU may wait for the next available SR resources that may have been reserved for PU detection indication. The WTRU may send positive energy on that resource.

SR resources that use PUCCH format 1 may be reused to signal PU detection. The SR that uses PUCCH format 1 may transmit a negative ACK (NACK) symbol, e.g., d(0)=1 for SR resources. The same PUCCH format 1 SR resource may be used, e.g., to transmit a PU detection with transmit d(0)=−1 for that SR resource.

The WTRU signalling PU detection may be based on the sr-ConfigIndex. The WTRU may identify the available SR resources that the WTRU may use in the PUCCH for SR and PU detection indication. These may be limited to resources that use PUCCH format 1. The WTRU may wait for the next available PUCCH format 1 SR resource, e.g., if a PU is detected by the WTRU. The WTRU may send d(0)=−1 on that resource. For regular transmission of SR, the WTRU may transmits d(0)=1 on the SR resource.

In addition to identify a subset of resources, the PU configuration index (e.g., pu-ConfigIndex) may be used to create additional resources. The PU configuration index may be used in a similar way (e.g., the PU configuration index may be associated with a table giving the periodicity and potentially the offset), but may represent new resources on PUCCH to transmit PU detection indication.

PU detection indications (e.g., MAC CE based, PUCCH based, etc.) may be applicable to RRC_CONNECTED WTRUs. It may be desirable for a WTRU to send PU detection in the case where the WTRU may be in RRC_IDLE mode, for example, where the WTRU may perform measurements for a PU in RRC_IDLE mode. An RACH-based PU detection indication may be used, which may allow for sending a PU indication in RRC_IDLE or RRC_CONNECTED mode. A WTRU that detects a PU may indicate the detection to the eNB by the transmission of a special or agreed upon random access preamble. This special random access preamble may be decided by the eNB and broadcast using the RACH configuration system information in SIB2.

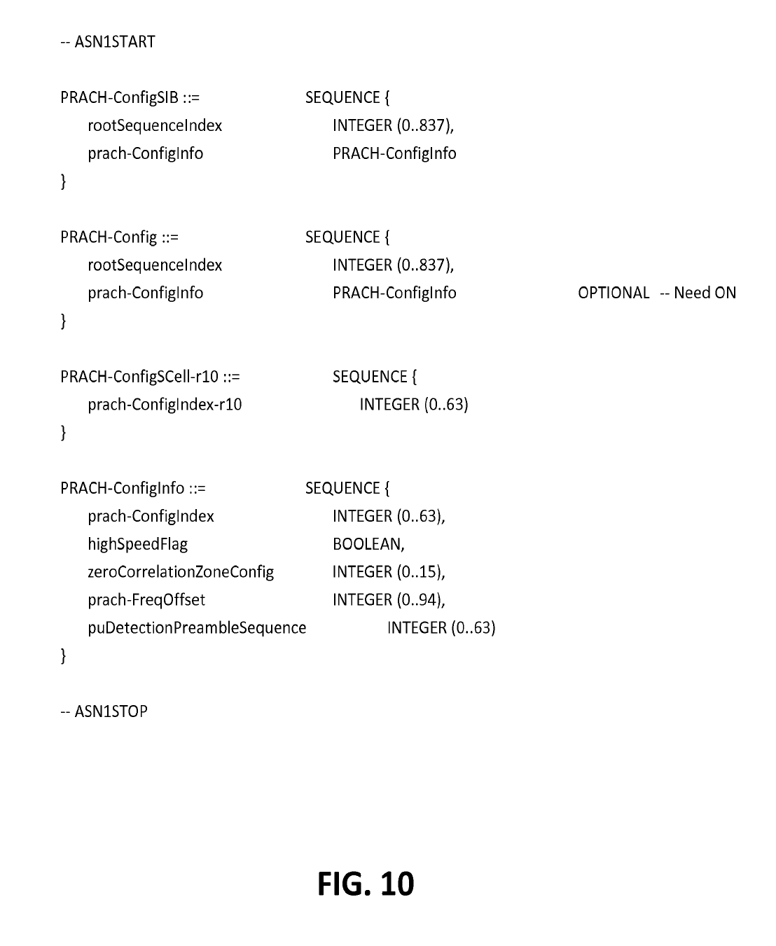

A set of preambles may be reserved to signal the PU detection. The eNB may determine which WTRU detected the PU based on the received preamble. WTRUs may be aware to use the PU detection random access preamble or one of the preambles in the set of PU detection random access preambles in the case of detection of a PU, and the eNB may be able to differentiate a normal RACH (for attach purposes, for example) from a RACH being used to signal detection of a PU. FIG. 10 illustrates an example of system information block (SIB), e.g., SIB2. As illustrated in FIG. 10 the SIB2 may include a puDetectionPreambleSequence field to indicate a preamble sequence.

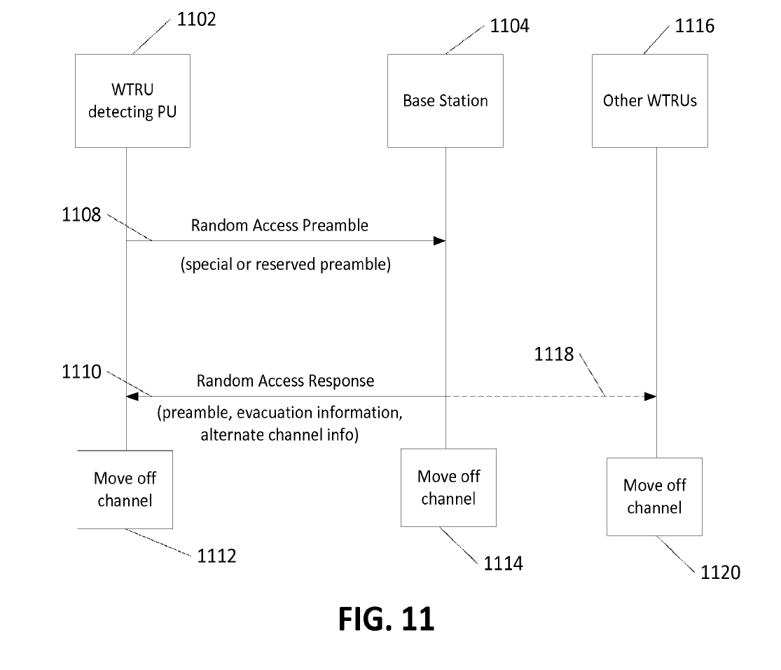

FIG. 11 illustrates an example of a RACH based PU detection. As illustrated in FIG. 11, at 1108, a WTRU 1102 that may detect a PU may transmit a RACH preamble with a specific or known sequence. The WTRU may wait for a RACH response on the Radio Network Temporary Identifier (RA-RNTI). The RACH preamble may be transmitted with incrementally increased transmit power, if the RACH response is not received. At 1110, the WTRU may receive a RACH response on the RA-RNTI, e.g., matching the RACH preamble. When the RACH response is received by the WTRU 1102, the WTRU 1102 may be made aware that the base station 1104 is aware of the PU detection indication that the WTRU has tried to transmit.

The RACH response may be used to evacuate each of the WTRUs on a channel. The RACH response to the special RACH preamble for PU detection may include the information about the evacuation of the channel, such as the delay with which the eNB may move off the channel, or the alternate channel information (e.g., instructions on how the WTRU may retrieve the alternate channel information). The WTRUs that operate on a PU assigned channel may monitor the RA-RNTI. As illustrated in FIG. 11, at 1112, the WTRUs may evacuate the PU assigned channel, e.g., on reception of a RACH response message with the special preamble sequence. At 1118, in addition to the WTRU 1102, other WTRUs 1116 may receive the evacuation information. At 1120, in addition to the WTRU 1102, the other WTRUs 1116 may evacuate the PU assigned channel. At 1114, the base station 1104 may move off the PU assigned channel. For example, the base station 1104 may move off the PU assigned channel after each of its attached WTRUs has been evacuated.

WTRU channel evacuation may be provided. The WTRU channel evacuation may be triggered by an evacuation event, e.g., the reception of a PU detection report from one or more WTRUs or reception of an evacuation command from the network. A low latency PU detection reporting may be used to report a PU detection event to an eNB, e.g., to comply with the channel move time requirements. The eNB may select a method to use for evacuation of the channel, e.g., in response to the evacuation event. For example, the eNB may select a Handover (HO) and/or connection release connection re-establishment method.

One or more evacuation methods may be used for each of the WTRUs, e.g., if multiple WTRUs need to be evacuated from a channel. The selection of an evacuation method for each WTRU or set of WTRUs may be conditioned upon several factors. The list of factors may include the event triggering the evacuation, e.g., the PU detection at the WTRU, evacuation request from network, whether localized or cell-wide evacuation may be required, the number of WTRUs to be evacuated, the priority/QoS of the services subscribed to or actively provided to the WTRU(s), and/or the traffic load of the neighboring cells, etc.

WTRU channel evacuation using a handover (HO) method may be provided. One or more WTRUs may be evacuated from a channel by performing a HO to a target cell providing coverage in the same area as the source cell. The target cell may operate on a different frequency. A base station may use reported WTRU measurements, entries in the NRT, etc. when selecting a target cell. For example, a PCI included in the PU detection report may be used as the target cell.

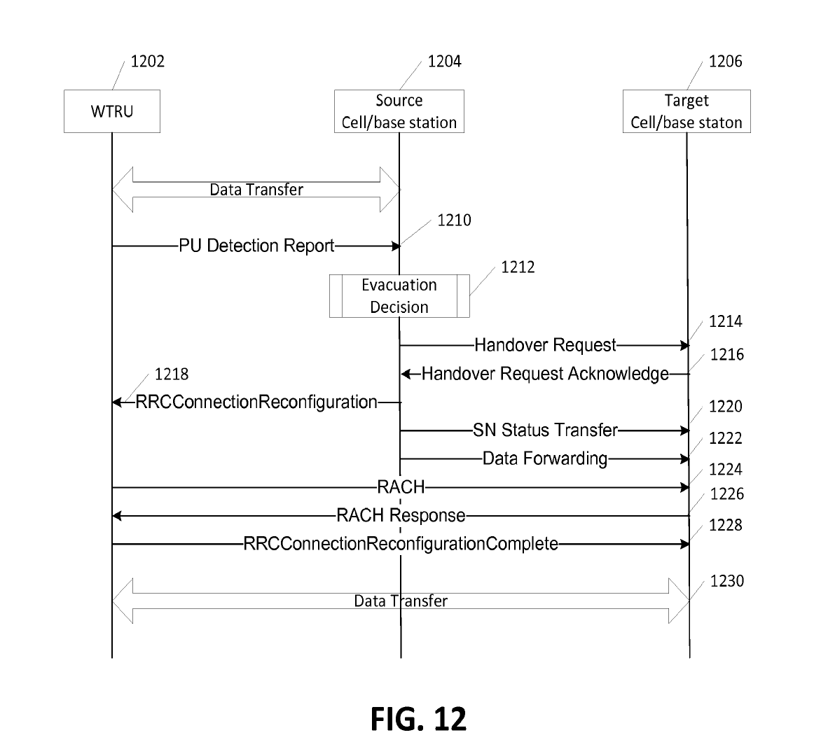

FIG. 12 illustrates an example of a WTRU channel evacuation. At 1210, a WTRU 1202 may send a PU detection report to a source cell/base station 1204. The source cell/base station may be the secondary user base station. The PU detection report may trigger the execution of evacuation procedure. The procedure may be triggered in response to other events, e.g., an evacuation command received from the network. At 1212, the source base station 1204 may make evacuation decision as described herein. The source base station 1204 may select a target cell or base station 1206. At 1214, the source base station 1204 may send a handover request to the selected target cell or base station 1206. At 1216, the source base station 1204 may receive a handover request acknowledgement from the target cell 1206. At 1218, the source base station 1204 may send a reconfiguration message (e.g., an RRCConnectionReconfiguration message) to the WTRU 1202. The reconfiguration message may include the selected target cell ID. The source base station may stagger the reconfiguration messages to one or more of the secondary user WTRUs. At 1220, the source base station 1204 may send a SN status transfer message to the target cell or base station 1206. At 1222, the source base station 1204 may forward data to the target cell or base station 1206. At 1224, the WTRU 1202 may send a RACH message to the target cell or base station 1206. At 1224 the RACH message from the WTRU 1202 to target cell or base station 1206 may be delayed. The RACH message delay may be a configurable delay. The WTRUs may be associated with different delay values to stagger the instant when the RACH message may be sent to the target cell or the base station. At 1226, the WTRU may receive a RACH response message from the target cell 1206. At 1228, the WTRU may send a reconfiguration complete message (e.g., RRCConnectionReconfigurationComplete message) to the target eNB 1206. At 1230, the WTRU 1202 may start data transfer with the target cell 1206.

In some cases, the HO command may not be received reliably by the WTRU. Or in the case of a cell-wide PU-detection event, the eNB may not be able to HO each of the WTRUs within a time period, e.g. 2 s in the case of operation in TVWS. Channel evacuation may occur, e.g., via the connection re-establishment procedure.

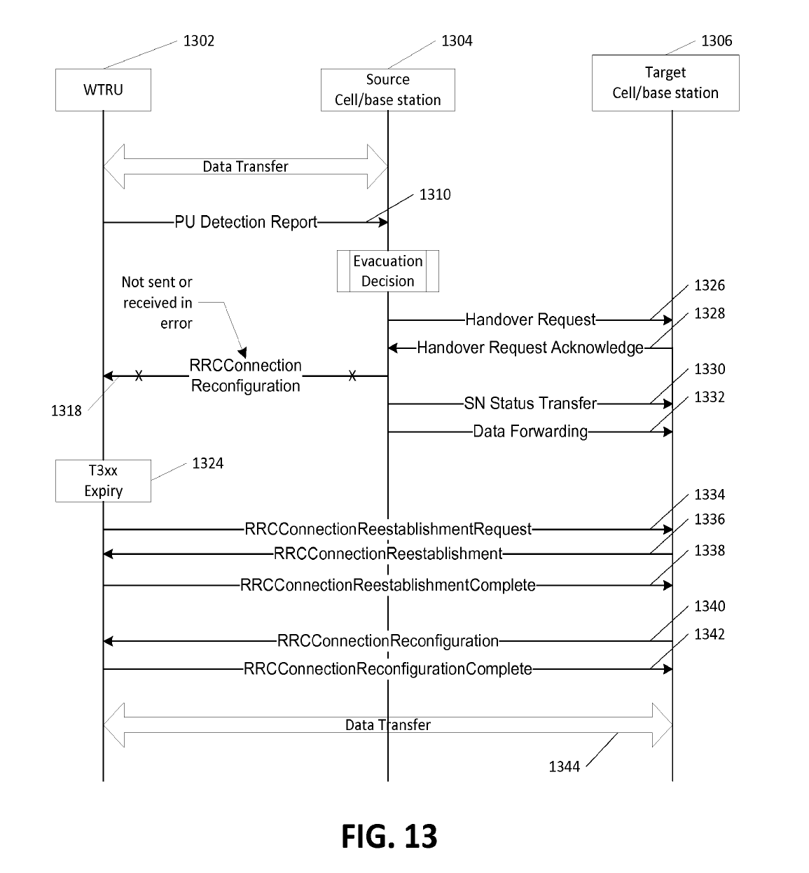

FIG. 13 illustrates an example of a WTRU channel evacuation procedure where the WTRU may evacuate the channel via the RRC Connection Re-Establishment procedure following a HO failure. For example, the channel evacuation may result due to poor signal quality at the WTRU. The licensee base station may choose not to send a handover (HO) command to one or more WTRUs, e.g., when evacuating a large number of WTRUs from the licensed channel. As illustrated in FIG. 13, at 1326, based on the received PU detection report 1310, the source cell or base station 1304 may send a HO request to the target cell or base station 1306. At 1328, the target cell or base station 1306 may acknowledge the HO request. At 1330 a sequence number (SN) status transfer message may be send from the source cell or base station 1304 to the target cell or base station 1306. The SN status transfer message may be sent over an X2 interface. At 1318, a reconfiguration message may not be received by the WTRU 1302 from the source eNB 1304. At 1330, the source cell or base station 1304 may start forwarding data to the target cell or base station 1306. The WTRU 1302 may start a timer such as T3xx Expiry timer 1324. The xx fields in the timer's name may be chosen such that the timer's name may be unique. The timer 1324 may be used to control the execution of the WTRU channel evacuation procedure. For example, the timer may be set upon detection of the PU (e.g., at 1310) and may be stopped upon reception of a HO or release command. The longer the timer value, the longer the WTRU may wait to receive a HO or release command. Upon expiry of the T3xx Expiry timer 1324, the WTRU 1302 may commence with the RRC Connection Re-Establishment procedure as described herein. The WTRU 1302 may commence with the RRC Connection Re-Establishment procedure with the target cell 1306 upon expiry of the T3xx expiry timer 1324. At 1334, the WTRU 1302 may send an RRC connection re-establishment request to the target cell or base station 1306. At 1336, the target cell or base station 1306 may send an RRC connection re-establishment response message to the WTRU 1302. At 1338, the WTRU 1302 may send an RRC connection re-establishment complete message to the target cell or base station 1306. At 1340, target cell or base station 1306 may send an RRC reconfiguration message to the WTRU 1302. The WTRU 1302 may reconfigure its resources based on the received RRC reconfiguration at 1340. At 1342, the WTRU 1302 may send an RRC reconfiguration complete message to the target cell or base station 1306. At 1344, data transfer between the WTRU 1302 and the target cell or base station 1306 may begin.

Different timer values may be used to stagger the re-establishment attempts for the WTRUs, e.g., to avoid a burst of re-establishment attempts. The timer value chosen for a WTRU or a set of WTRUs may be used to prioritize the order in which the WTRUs re-establish the RRC connection with the network. For example, high priority WTRUs may use a short timer value, and low priority WTRUs may use a long timer value.

Channel evacuation via a connection release procedure may be performed when evacuation of the channel via HO may not be possible, e.g., when a target cell rejects admission of the WTRU due to high traffic load. Or in the case of low activity at the WTRU, maintaining the connection during the evacuation may not be needed. Channel evacuation via a connection release procedure may be performed.

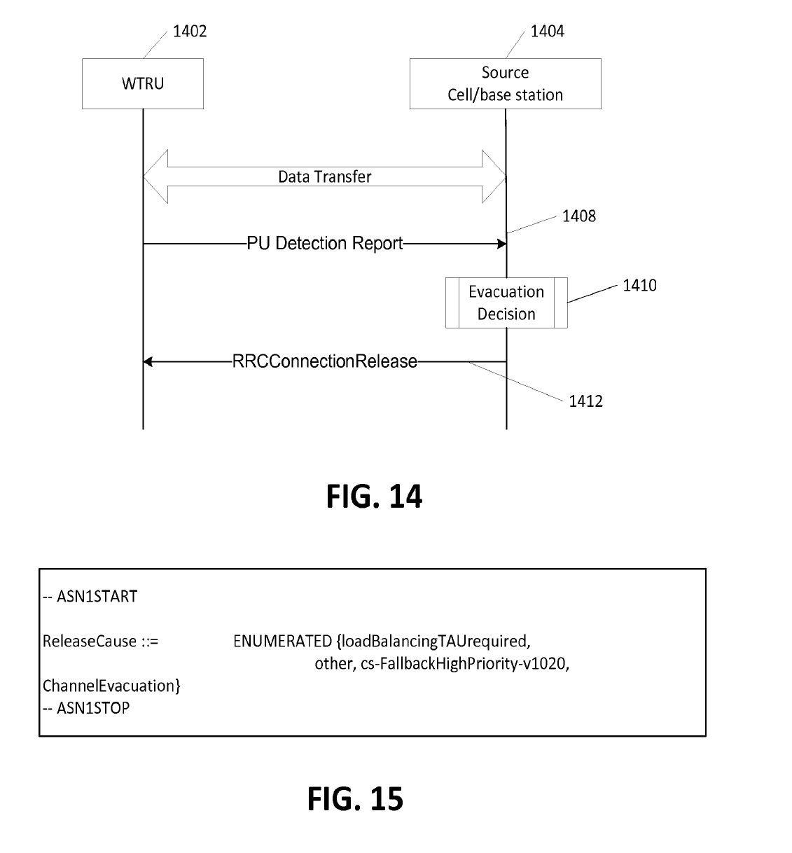

FIG. 14 illustrates an example of channel evacuation via the RRC connection release procedure. As illustrated in FIG. 14, at 1408, a source eNB 1404 may receive a PU detection report from the WTRU 1402. The PU detection report may include the event that may trigger the execution of the evacuation procedure. The evacuation procedure may be triggered in response to other events, e.g. an evacuation command received from the network. At 1412, the source cell or base station 1404 may send a release message (e.g., RRCConnectionRelease message) after making the evacuation decision at 1410.

A release cause information element (IE) in the RRCConnectionRelease message may be used to indicate the reason for releasing the RRC Connection. FIG. 15 illustrates an example of a release cause IE. The release cause IE may include parameter to indicate a reason for release of an RRC connection. For example, the release cause IE may indicate the release to be one initiated by the network (e.g., in case of load balancing of WTRUs, in case of PU detection by a WTRU, etc.). The release cause IE may indicate the release cause using an enumerated value. A lower latency mechanism such as a downlink (DL) medium access control (MAC) control element (CE) may be used to signal the connection release to the WTRU.

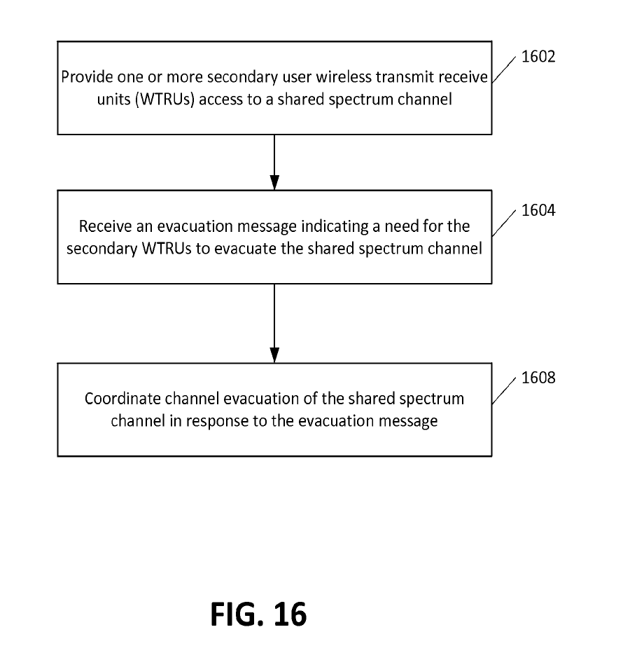

FIG. 16 illustrates an example of a channel evacuation method. At 1602, a secondary user (e.g., a secondary user base station) may provide one or more secondary user wireless transmit receive units (WTRUs) with access to a shared spectrum channel. At 1604, the secondary user may receive an evacuation message. For example, the evacuation message may include a system evacuation message. The evacuation message may indicate a need for the secondary user WTRUs to evacuate the shared spectrum channel. At 1608, the secondary user may coordinate channel evacuation of the shared spectrum channel in response to the evacuation message.

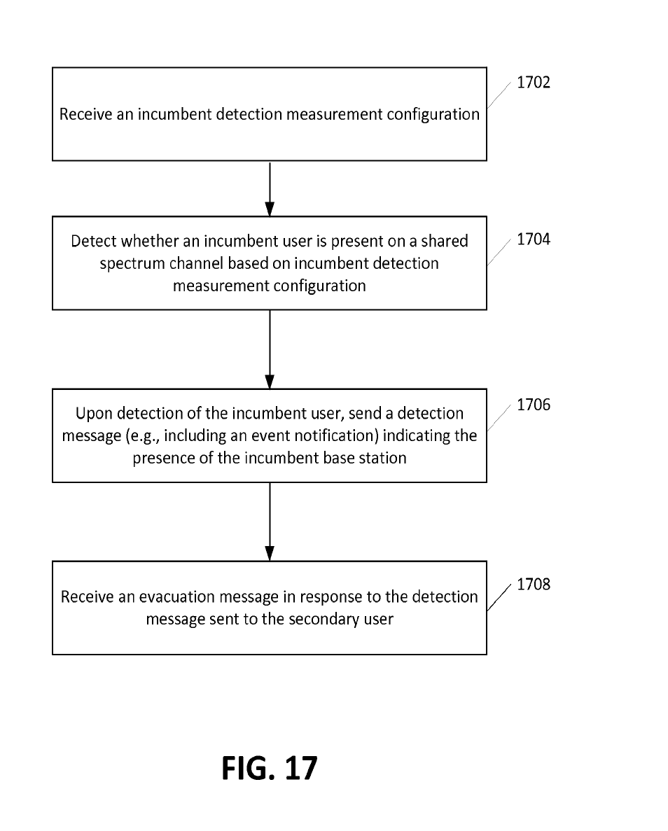

FIG. 17 illustrates an example of detecting presence of an incumbent user and reporting the presence of the incumbent user to a secondary user. At 1702, a secondary user WTRU may receive an incumbent detection measurement configuration. At 1704, the secondary user WTRU may detect whether an incumbent user is present on a shared spectrum channel based on the incumbent detection measurement configuration. At 1706, the secondary user WTRU may send a detection message upon detection of the incumbent user. The detection message may include an event notification indicating the presence of the incumbent user. At 1708, the secondary user WTRU may receive an evacuation message in response to the detection message.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU. WTRU terminal, base station. RNC, or any host computer.

1. A channel evacuation method comprising:
providing one or more secondary user wireless transmit receive units (WTRUs) with access to a shared spectrum channel;
receiving an evacuation message indicating need for the secondary user WTRUs to evacuate the shared spectrum channel, wherein the evacuation message comprises an alternate channel for use by the secondary user WTRUs; and
coordinating channel evacuation of the shared spectrum channel with the secondary user WTRUs, in response to the evacuation message.

2. The method of claim 1, further comprising sending an evacuation complete message to an incumbent user, wherein the evacuation complete message indicates evacuation completion of the shared spectrum channel.

3. The method of claim 1, wherein the evacuation message comprises a system evacuation message received from an incumbent user.

4. The method of claim 3, wherein the system evacuation message comprises an X2 message received via an X2 interface.

5. (canceled)

6. The method of claim 1, wherein the evacuation message is received from a management entity based on a pre-determined channel evacuation time.

7. The method of claim 6, wherein the pre-determined channel evacuation time is based on an agreement between an incumbent system operator and a secondary user operator.

8. The method of claim 6, wherein the pre-determined channel evacuation time is periodic and is based on an allowed time for the use of the shared spectrum channel by the secondary user WTRUs.

9. The method of claim 1, wherein the shared spectrum channel is a licensed shared access (LSA) channel.

10. The method of claim 1, further comprising:
sending a measurement event configuration to the secondary user WTRUs, wherein the measurement event configuration comprises at least one of a public land mobile network identifier (PLMN ID) associated with an incumbent base station or a request for performing a PLMN search on the shared spectrum channel based on the PLMN ID,
wherein the evacuation message is received in response to the measurement event configuration, and comprises an event notification indicating presence of the incumbent base station on the shared spectrum channel.

11. The method of claim 1, wherein the evacuation message is received from a database or a broker, and further comprising:
checking a shared spectrum channel status with a database or a broker to determine the need to evacuate the shared spectrum channel, and wherein the evacuation message is received in response to the shared spectrum channel status check.

12. (canceled)

13. The method of claim 1, wherein the coordinating channel evacuation of the secondary user WTRUs further comprises:
selecting a target cell based on at least one of an event notification, a secondary user WTRU measurement report, or an neighbor relational table (NRT) entry; and
sending a handover request to the target cell.

14-27. (canceled)

28. A secondary user base station configured to cause channel evacuation, the secondary user base station comprising:
a processor configured to
provide one or more secondary user wireless transmit receive units (WTRUs) with access to a shared spectrum channel;
receive an evacuation message indicating need for the secondary user WTRUs to evacuate the shared spectrum channel, wherein the evacuation message comprises an alternate channel for use by the secondary user WTRUs; and
coordinate channel evacuation of the shared spectrum channel with the secondary user WTRUs, in response to the evacuation message.

29. The secondary user base station of claim 28, wherein the processor is further configured to send an evacuation complete message to an incumbent user, wherein the evacuation complete message indicates evacuation completion of the shared spectrum channel.

30-32. (canceled)

33. The secondary user base station of claim 28, wherein the evacuation message is received from a management entity based on a pre-determined channel evacuation time; and wherein the pre-determined channel evacuation time is based on an agreement between an incumbent system operator and a secondary user operator.

34. (canceled)

35. The secondary user base station of claim 33, wherein the pre-determined channel evacuation time is periodic and is based on an allowed time for the use of the shared spectrum channel by the secondary user WTRUs; and wherein the pre-determined channel evacuation time is periodic and is based on an allowed time for the use of the shared spectrum channel by the secondary user WTRUs.

36. (canceled)

37. The secondary user base station of claim 28, wherein the processor is further configured to:
send a measurement event configuration to the secondary user WTRUs, wherein the measurement event configuration comprises at least one of a public land mobile network identifier (PLMN ID) associated with an incumbent base station or a request for performing a PLMN search on the shared spectrum channel based on the PLMN ID,
wherein the evacuation message is received in response to the measurement event configuration, and comprises an event notification indicating presence of the incumbent base station on the shared spectrum channel.

38. (canceled)

39. The secondary user base station of claim 28, wherein the processor is further configured to check a shared spectrum channel status with a database or a broker to determine the need to evacuate the shared spectrum channel, and wherein the evacuation message is received in response to the shared spectrum channel status check.

40. The secondary user base station of claim 28, wherein to coordinate channel evacuation of the secondary user WTRUs the processor is further configured to:
select a target cell based on at least one of an event notification, a secondary user WTRU measurement report, or an neighbor relational table (NRT) entry; and
send a handover request to the target cell.

41. The secondary user base station of claim 28, wherein the evacuation message further indicates need for the secondary user base station to evacuate the shared spectrum channel.

42-54. (canceled)

55. The method of claim 1, further comprising determining a need for the secondary user WTRU to leave the shared spectrum.
